(19) United States
(12) Patent Application Publication
(10) Pub. No.: US 2026/0195699 A1
(43) Pub. Date: Jul. 9, 2026

(54) ONLINE SERVICE PROVIDER (OSP) DETERMINING A RESOURCE CODE BASED ON ONE OR MORE ATTRIBUTES OF AN ITEM ASSOCIATED WITH A RELATIONSHIP INSTANCE

(71) Applicant: Avalara, Inc., Durham, NC (US)

(72) Inventors: Andrew Brandon Chan, Chapel Hill, NC (US); Michael J. Maselli, Cary, NC (US); Jurgis Vilis, Toronto (CA); Thomas Goldschmidt, Karlsdorf-Neuthard (DE); Nicolas Nicolov, Dripping Springs, TX (US)

(21) Appl. No.: 19/558,193

(22) Filed: Mar. 5, 2026

Related U.S. Application Data
(63) Continuation of application No. 18/318,514, filed on May 16, 2023.

(51) Int. Cl. G06Q 10/0831; G06Q 40/12

(52) U.S. Cl. CPC G06Q 10/0831; G06Q 40/123

(57) ABSTRACT

Systems and method electronically generate a resource code for an item based on attributes of the item and a proposed relationship instance associated with the item. Entities are often required to identify a resource code for items that move between jurisdictions. The systems and methods described herein allow entities to easily obtain resource codes for items moving between jurisdictions.

### BACKGROUND

Items associated with relationship instances between entities in different jurisdictions are classified with one or more resource codes. A resource code represents one or more attributes of an item.

All subject matter discussed in this Background section of this document is not necessarily prior art, and may not be presumed to be prior art simply because it is presented in this Background section. Plus, any reference to any prior art in this description is not, and should not be taken as, an acknowledgement or any form of suggestion that such prior art forms parts of the common general knowledge in any art in any country. Along these lines, any recognition of problems in the prior art discussed in this Background section or associated with such subject matter should not be treated as prior art, unless expressly stated to be prior art. Rather, the discussion of any subject matter in this Background section should be treated as part of the approach taken towards the particular problem by the inventors. This approach in and of itself may also be inventive.

### BRIEF SUMMARY

The present description gives instances of computer systems, storage media that may store programs, and methods. Embodiments of the system identify one or more attributes of an item, such as by identifying the one or more attributes in an image or other item-sensed data. The item is subject to digital rules based on the resource code classification of the item when the item moves between a first jurisdiction and a second jurisdiction. The attributes are applied to a machine learning model to accurately classify the item based on at least one resource code. By accurately classifying the item based on the at least one resource code the system is able to determine which digital rules apply to the relationship instance with little to no user input.

Providing, in a timely and efficient manner, accurate and reliable resource codes present a technical problem for relationship instances that include items which move between a first domain and a second domain. Such resource codes are dependent on the attributes of the items and digital rules related to the resource codes and domains. Current methods of determining a resource code for an item involve subject-matter experts analyzing data regarding the item to determine attributes of the item. The subject-matter experts determine which resource codes apply to the item based on the attributes. Computing resources, such as processing power and memory to facilitate user interfaces and data transmission between each entity associated with the relationship instance, are expended in supporting the subject-matter expert to determine the resource codes. Furthermore, because the subject-matter expert determines the resource codes, the entities must wait until the expert has made their determination before digital rules regarding the relationship instance can be determined and before the relationship instance can proceed.

In embodiments, the system accesses a dataset that indicates a relationship instance between a primary entity associated with a first domain and a secondary entity associated with a second domain. The system extracts one or more attributes of an item associated with the relationship instance from the dataset. In some embodiments, the dataset includes item-sensed data indicative of the item, and the system extracts the one or more attributes based on the item-sensed data, such as by generating item identity data indicating the identity of the item. In some embodiments, the item-sensed data is an image of the item.

Additionally, the system applies the attributes related to the item, the first domain, the second domain, and the primary and secondary entities to a machine learning model to obtain one or more resource codes. The system looks up one or more digital rules applying to the relationship instance based on the first and second domain and the relationship instance. The system determines a resultant resource code based on the one or more resource codes, the one or more digital rules, the one or more attributes, and the first and second domain.

Furthermore, the system collects data regarding clarification of resource codes for items to improve the system's ability to determine future resource codes. In some embodiments the system determines whether one or more resource codes are accurate and receives additional data used to determine a resultant resource code for the item. For example, the system may use output from a machine learning model that generates one or more resource codes to determine whether the resource codes are accurate. In another example, the system may receive additional data based on answers to prompts generated from digital rules. In such embodiments, the system may use answers to prompts, output from the machine learning model, or other data, to re-train machine learning models used to identify items, generate resource codes, or perform other functions of the system described herein.

The present disclosure provides systems, computer-readable media, and methods that solve these technical problems by increasing the speed, efficiency and accuracy of such specialized software platforms and computer networks, thus improving the technology of software applications, such as in ERP and accounting software applications. By providing a system that determines resource codes with minimal to no input from subject-matter experts, computing devices used by subject-matter experts to determine resource codes are able to conserve processing power, memory, network resources, and other computing resources. For example, determining a resource code on an Online Software Platform via the system described herein instead of transmitting information to a subject-matter expert and receiving a resource code back from the expert conserves bandwidth and other networking resources for the Online Software Platform and for computer systems operated by the subject-matter expert, and may also conserve processing power, memory, and other computing resources related to displaying the information to the subject-matter expert. Furthermore, by reducing the amount of time needed to determine and apply resource codes, the system is able to more quickly determine digital rules related to the relationship instance. As shown above and in more detail throughout the present disclosure, the present disclosure provides technical improvements in computer networks to existing computerized systems to provide accurate and timely resource codes for relationship instances that involve entities that are located in different domains.

These and other features and advantages of the claimed invention will become more readily apparent in view of the embodiments described and illustrated in this specification, namely in this written specification and the associated drawings.

### BRIEF DESCRIPTION OF THE DRAWINGS

FIG. 1 is a diagram showing sample aspects of embodiments.

FIG. 2 is a diagram showing details and aspects of different types of possible embodiments of the digital resource rules of FIG. 1.

FIG. 3 is a diagram of sample aspects of a primary entity, according to various embodiments described herein.

FIG. 4 is a diagram of sample aspects of an online software platform, according to various embodiments described herein.

FIG. 5 is a diagram of sample aspects of an item recognition engine, according to various embodiments described herein.

FIG. 6 is a flowchart for illustrating a sample method for receiving data derived from item-sensed data related to a potential relationship instance, according to various embodiments described herein.

FIG. 7 is a flowchart for illustrating a sample method for generating a resource code for an item, according to various embodiments described herein.

FIG. 8 is a flowchart for illustrating a sample method for generating item identity data to extract attributes related to an item, according to various embodiments described herein.

FIG. 9A is a flowchart for illustrating a sample method to extract attributes related to an item based on image descriptive text, according to various embodiments described herein.

FIG. 9B is a flowchart for illustrating another sample method to extract attributes related to an item based on image descriptive text, according to various embodiments described herein.

FIG. 10 is a flowchart for illustrating another sample method to identify a resource code for an item based on answers to prompts, according to various embodiments described herein.

FIG. 11 is a flowchart for illustrating another sample method to identify data for retraining a machine learning model to output one or more resource codes, according to various embodiments described herein.

FIG. 12A is a flowchart for illustrating another sample method to obtain training data to train, or re-train, a machine learning model that outputs one or more resource codes, according to various embodiments described herein.

FIG. 12B is a flowchart for illustrating another sample method to obtain training data to train, or re-train, a machine learning model to generate resource codes, according to various embodiments described herein.

FIG. 13 is a hardware diagram that shows details for a sample computer system and for a sample computer system.

FIG. 14 is a diagram for an operational example where a buy-sell transaction is a use case of the relationship instance.

FIG. 15 is a flowchart for illustrating a sample method for receiving data derived from item-sensed data related to a transaction to determine an HS code for the transaction, according to various embodiments described herein.

FIG. 16 is a flowchart for illustrating a sample method for generating an HS code for an item in a transaction, according to various embodiments described herein.

FIG. 17 is a flowchart for illustrating a sample method for to identify data for retraining a machine learning model to output one or more HS codes, according to various embodiments described herein.

FIG. 18A is a display diagram showing sample view of a User Interface, shown on a screen, according to various embodiments described herein.

FIG. 18B is a display diagram showing sample view of a User Interface, shown on a screen, according to various embodiments described herein.

FIG. 18C is a display diagram showing sample view of a User Interface, shown on a screen, according to various embodiments described herein.

FIG. 19 is a display diagram showing sample view of a User Interface, shown on a screen, according to various embodiments described herein.

FIG. 20 is a display diagram showing sample view of a User Interface, shown on a screen, according to various embodiments described herein.

### DETAILED DESCRIPTION

As has been mentioned, the present description is about computer systems, storage media that may store programs, and methods. Embodiments are now described in more detail.

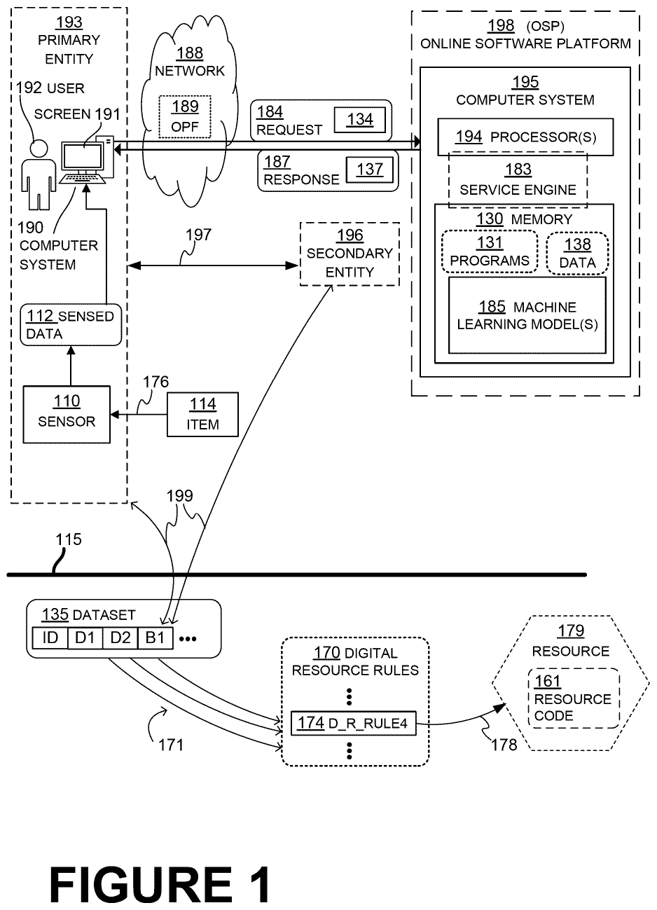

FIG. 1 is a diagram showing sample aspects of embodiments. A thick horizontal line 115 separates this diagram, although not completely or rigorously, into a top portion and a bottom portion. Above the line 115 are shown elements with emphasis mostly on entities, components, their relationships, and their interactions, while below the line 115 are shown elements with emphasis mostly on processing of data that takes place often within one or more of the components that are above the line 115.

Above the line 115, a sample computer system 195 according to embodiments is shown. The computer system 195 has one or more processors 194 and a memory 130. The memory 130 stores programs 131, data 138, and one or more machine learning models 185. The one or more processors 194 and the memory 130 of the computer system 195 thus implement a service engine 183.

The computer system 195 can be located in “the cloud.” In fact, the computer system 195 may optionally be implemented as part of an Online Software Platform (OSP) 198. The OSP 198 can be configured to perform one or more predefined services, for example via operations of the service engine 183. Such services can be searches, determinations, computations, verifications, notifications, the transmission of specialized information, including data that effectuates payments, the generation and transmission of documents, the online accessing of other systems to effect registrations, and so on, including what is described in this document. Such services can be provided in the form of Software as a Service (SaaS). As such, the OSP 198 can be an online service provider.

The user 192 may represent a single user or multiple users. The user 192 may use a computer system 190 that has a screen 191, on which User Interfaces (UIs) may be shown. In embodiments, the user 192 and the computer system 190 are considered part of a primary entity 193. In such instances, the user 192 can be an agent of the primary entity 193, and even within a physical site of the entity 193, although that is not necessary. In embodiments, the computer system 190 or other device of the user 192 can be client devices for the computer system 195. The user 192 or the primary entity 193 can be clients for the OSP 198. For instance, the user 192 may log into the computer system 195 by using credentials, such as a user name, a password, a token, and so on.

The computer system 190 may access the computer system 195 via a communications network 188, such as the Internet. In particular, the entities and associated systems of FIG. 1 may communicate via physical and logical channels of the communication network 188. For example, information may be communicated as data using the Internet Protocol (IP) suite over a packet-switched network such as the Internet or other packet-switched network, which may be included as part of the communication network 188. The communication network 188 may include many different types of computer networks and communication media, including those used by various different physical and logical channels of communication, now known or later developed. Non-limiting media and communication channel examples include one or more, or any operable combination of: fiber optic systems, satellite systems, cable systems, microwave systems, Asynchronous Transfer Mode (“ATM”) systems, frame relay systems, Digital Subscriber Line (“DSL”) systems, Radio Frequency (“RF”) systems, telephone systems, cellular systems, other wireless systems, and the Internet. In various embodiments the communication network 188 can be or include any type of network, such as a Local Area Network (LAN), a Metropolitan Area Network (MAN), a Wide Area Network (WAN), or the Internet. Accordingly, from certain perspectives, the OSP 198 is in the cloud, and is therefore depicted in FIG. 1 within the communication network 188.

The computer system 190 may receive sensed data 112 from a sensor 110. The sensor 110 may be a barcode reader, RFID reader, camera, QR code reader, infrared sensor, or any other type of sensor or group of sensors that are usable to sense an item, and may be incorporated in a device of any type. The sensor 110 may be used to sense an item, such as the item 114 as indicated by the connector 176. The sensor 110 transmits sensed data received by sensing the item, such as sensed data 112, to the computer system 190. Although a single sensor 110 is shown in FIG. 1, embodiments are not so limited, and the primary entity 193 may be associated with multiple sensors that are each able to obtain sensed data regarding items. Additionally, in some embodiments, the computer system 190 is a mobile device, tablet, or any portable device capable of communicating, interacting and exchanging data with the sensor 110 and with the OSP 198. The computer system 190 may be a single device or multiple devices, which may be a combination of different types of devices.

Accessing, downloading and/or uploading, and so on may be permitted among these computer systems. Such can be performed, for instance, with manually uploading files, like spreadsheet files, etc. Such can also be performed automatically as shown in the example of FIG. 1, with systems exchanging requests and responses.

Moreover, in some embodiments, data from the computer system 190 and/or from the computer system 195 may be stored in an Online Processing Facility (OPF) 189 that can run software applications, perform operations, and so on. In such embodiments, requests and responses may be exchanged with the OPF 189, downloading or uploading may involve the OPF 189, and so on. In such embodiments, the computer system 190 and any devices of the OPF 189 can be considered to be remote devices, at least from the perspective of the computer system 195.

In some instances, the user 192 and/or the primary entity 193 have instances of relationships with secondary entities. Only one such secondary entity 196 is shown, for illustration purposes, however there can be more than one secondary entity. In this example, the primary entity 193 has a relationship instance 197 with the secondary entity 196.

In some instances, the user 192 and/or the primary entity 193 obtain data about one or more secondary entities, for example as necessary for conducting the relationship instances with them. The primary entity 193 and/or the secondary entity 196 may be referred to as simply entities. One of these entities may have one or more attributes. Such an attribute of such an entity may be any one of its name, type of entity, a physical or geographical location such as an address, a contact information element, an affiliation, a characterization of another entity, a characterization by another entity, an association or relationship with another entity (general or specific instances), an asset of the entity, a declaration by or on behalf of the entity, a specific domain that the entity belongs in a context of multiple domains that are defined in terms of the above, and so on.

In embodiments, the computer system 195 receives one or more datasets. A sample received dataset 135 is shown below the line 115. The dataset 135 may be received by the computer system 195 in a number of ways. In some embodiments, one or more requests containing the dataset may be received by the computer system 195 via a network. In this example, a request 184 is received by the computer system 195 via the network 188. The request 184 has been transmitted by the remote computer system 190. The received one or more requests can carry payloads. In this example, the request 184 carries a payload 134. In such embodiments, the one or more payloads may be parsed by the computer system 195 to extract the dataset. In this example, the payload 134 can be parsed by the computer system 195 to extract the dataset 135. In this example the single payload 134 encodes the entire dataset 135, but that is not required. In fact, a dataset can be received from the payloads of multiple requests. In such cases, a single payload may encode only a portion of the dataset. And, of course, the payload of a single request may encode multiple datasets. Additional computers may be involved with the network 188, some beyond the control of the user 192 or OSP 198, and some within such control.

The dataset 135 has values that can also be called dataset values. The dataset values can be numerical, alphanumeric, Boolean, and so on, as needed for what the values characterize. For example, an identity value ID may indicate an identity of the dataset 135, so as to differentiate it from other such datasets. At least one of the dataset values may characterize an attribute of a certain one of the entities 193 and 196, as indicated by correspondence arrows 199. For instance, a value D1 may be the name of the certain entity, a value D2 may be for relevant data of the entity, and so on. Plus, an optional value B1 may be a numerical base value. The database value B1 can be for an aspect of the dataset, and so on. The aspect of the dataset may be the aspect of a value that characterizes the attribute, an aspect of the reason that the dataset was created in the first place, and so on. The dataset 135 may further have additional dataset values, as indicated by the horizontal ellipses in the right side of the dataset 135. (Each time, the ellipses suggest possibly more of what it follows.) In some embodiments, the dataset 135 has values that characterize attributes of both the primary entity 193 and the secondary entity 196, but that is not required. In some embodiments, the dataset 135 has values that indicate the attributes of an item, such as the item 114. The values that indicate the attributes of an item may be determined based on item-sensed data, such as the sensed data 112 received by the computer system 190 from the sensor 110.

In embodiments, digital resource rules 170 are provided for use by the OSP 198. In the example of this diagram, only one sample digital resource rule is shown explicitly, namely rule D_R_RULE4 174. All other such rules are indicated by the vertical ellipses. These rules 170 are digital in that they are implemented for use by software. For example, these rules 170 may be implemented within programs 131, data 138, and machine learning model(s) 185. The data portion of these rules 170 may alternately be stored in memories, local or in other places that can be accessed by the computer system 195. The storing can be in the form of a spreadsheet, a database, etc.

In embodiments, the computer system 195 may access the stored digital resource rules 170. This accessing may be performed responsive to the computer system 195 receiving a dataset, such as the dataset 135. For example, the computer system 195 may access the stored digital resource rules 170 to determine a classification or resource code for an item, such as the resource code 161 and item 114 respectively. In another example, the computer system 195 may access the stored digital resource rules 170 to generate data regarding the proposed relationship instance 197 based on a resource code, such as the resource code 161, determined for an item.

The computer system 195 may select a certain one of the accessed digital resource rules 170. In this example, the rule D_R_RULE4 174 is thus selected as the certain digital resource rule. The selection of this particular rule is indicated also by the fact that an arrow 178 begins from that rule. The arrow 178 is described in more detail later in this document. The computer system 195 may thus select the certain rule D_R_RULE4 174 responsive to one or more of the dataset values of the dataset 135. The impact of the dataset 135 in the selection is indicated by at least some of the arrows 171.

The computer system 195 may produce a resource for the dataset 135, such as the resource 179. The computer system 195 may thus produce the resource by applying the certain digital resource rule, which was previously selected, to at least one of the dataset values of the dataset 135. In the example of FIG. 1, the resource 179 is produced for the dataset 135 by the computer system 195 applying the certain digital resource rule D_R_RULE4 174, as indicated by the arrow 178. The impact of the dataset 135 in producing the resource 179 is indicated by at least one of the arrows 171. The resource 179 may include a resource code 161. The resource code 161 may be determined as part of producing a resource, such as the resource 179. Furthermore, the resource code 161 represents a classification of an item indicated in the dataset 135. In some embodiments, a resource code is used by the computer system 195 to produce the resource 179.

The produced resource can be a document, a determination, a computational result, etc., made, created or prepared for the user 192, and/or the primary entity 193, and/or the secondary entity 196, etc. As such, in some embodiments, the resource is produced by processing and/or a computation. In some embodiments, therefore, the resource is produced on the basis of a characterized attribute of the primary entity 193 and/or the secondary entity 196. In some embodiments, the resource is produced on the basis of the item 114 or one or more aspects of a combination of items represented by the item 114, and at least one characterized attribute of the primary entity 193 and/or the secondary entity 196.

The resource may be produced in a number of ways. For instance, at least one of the dataset values of the dataset 135 can be a numerical base value, e.g., B1, as mentioned above. In such cases, applying the certain digital resource rule may include performing a mathematical operation on the base value B1. For example, applying the certain digital resource rule may include multiplying the numerical base value B1 with a number indicated by the certain digital resource rule. Such a number can be, for example, a percentage, e.g., 1.5%, 3%, 5%, and so on. Such a number can be indicated directly by the certain rule, or be stored in a place indicated by the certain rule, or by the dataset 135, and so on.

In some embodiments, two or more digital main rules may be applied to produce the resource. For example, the computer system 195 may select, responsive to one or more of the dataset values, another one of the accessed digital resource rules 170. These one or more dataset values can be the same as, or different than, the one or more dataset values responsive to which the first selected rule was selected. In such embodiments, the resource can be produced by the computer system 195 also applying the other selected digital resource rule to at least one of the dataset values. For instance, where the base value B1 is used, applying the first selected rule may include multiplying the numerical base value B1 with a first number indicated by the first selected rule, so as to compute a first product. In addition, applying the second selected rule may include multiplying the numerical base value B1 with a second number indicated by the second selected rule, so as to compute a second product. And, a value of the resource may be produced by summing the first product and the second product.

In some embodiments, the resource code 161 is determined by applying one or more machine learning models, such as the machine learning model(s) 185, to one or more values of the dataset. The machine learning model(s) 185 may output one or more resource codes which are applied to one or more digital rules to determine a resultant resource code, such as the resource code 161.

As seen above, the computer system 190, the computer system 195, and possibly also the OPF 189 may exchange requests and responses. Such can be implemented with a number of different architectures. Two examples are now described with reference to the computer systems 190 and 195 only.

In one such architecture, a device remote to the service engine 183, such as the computer system 190, may have a certain application (not shown) and a connector (not shown) that is a plugin that sits on top of that certain application. The computer system 190 via the connector may be able to fetch from the remote device the details required for the service desired from the OSP 198, form an object or payload (e.g., 134), and then send or push a request (e.g., 184) that carries the payload to the service engine 183 via a service call. The service engine 183 may receive the request with its payload. The service engine 183 may then access the digital resource rules 170, find the appropriate one(s) of them, and apply it or them to the payload to produce the requested resource 179. The service engine 183 may then form a payload (e.g., 137) that includes an aspect of the resource 179, and then push, send, or otherwise cause to be transmitted a response (e.g., 187) that carries the payload it formed to the connector. The computer system 190 via the connector receives the response, reads its payload, and forwards that payload to the certain application.

An alternative such architecture uses Representational State Transfer (REST) Application Programming Interfaces (APIs). REST or RESTful API design is designed to take advantage of existing protocols. While REST can be used over nearly any protocol, it usually takes advantage of Hyper Text Transfer Protocol (HTTP) when used for Web APIs. In such an alternative architecture, a device remote to the service engine 183, such as the computer system 190, may have a particular application (not shown). In addition, the computer system 195 implements a REST API (not shown). This alternative architecture enables the primary entity 193 to directly consume a REST API from their particular application, without using a connector. The particular application of the remote device may be able to fetch internally from the remote device the details required for the service desired from the OSP 198, and thus send or push the request 184 to the REST API. In turn, the REST API talks in the background to the service engine 183. Again, the service engine 183 determines the requested resource 179, and sends an aspect of it back to the REST API. In turn, the REST API sends the response 187 that has the payload 137 to the particular application.

Referring again to the digital resource rules 170, digital rules in embodiments can be expressed in the form of a logical “if-then” statement, such as: “if P then Q”. In such statements, the “if” part, represented by the “P”, is called the condition, and the “then” part, represented by the “Q”, is called the consequent. In a set of digital rules, the condition or the consequent may be repeated. For instance, the condition can be the same for multiple different rules. And the consequent can be the same for multiple different rules.

Searching for a rule that applies can be performed by searching for whether or not the rule's one or more conditions are met. The computer system may recognize that such a condition is met. For instance, the certain condition could define a boundary of a region that is within a space. The region could be geometric, and be within a larger space. The region could be geographic, within the space of a city, a state, a country, a continent or the earth. The boundary of the region could be defined in terms of numbers according to a coordinate system within the space. In the example of geography, the boundary could be defined in terms of groups of longitude and latitude coordinates. For instance, the attribute could be a location of the entity, and the one or more values of the dataset 135 that characterize the location could be one or more numbers or an address, or longitude and latitude. A condition can be met depending on how the one or more values compare with the boundary. For example, the comparison may reveal that the location is in the region instead of outside the region. The comparison can be made by rendering the characterized attribute in units comparable to those of the boundary. For example, the characterized attribute could be an address that is rendered into longitude and latitude coordinates, and so on.

The search can be iterative through all the digital rules of a set of rules or of a subset of rules. Sometimes once the condition of one rule is met, its consequent is applied, and the search effectively stops. Other times, all eligible rules are searched, and those whose conditions are met are marked for later consideration and application, for instance by proper implementation of the consequent.

The digital resource rules 170 includes the rule D_R_RULE4 174 that is eventually selected and applied. In some embodiments, the rules 170 are implemented by simple rules. A simple rule has a single condition (“P”), and a single consequent (“Q”). As a result of an initial search, then, the digital resource rule D_R_RULE4 174 is selected, and then its consequent is applied to produce the resource.

In some embodiments, the rules 170 further include additional digital resource rules that select that digital resource rule D_R_RULE4 174 in the first place, for ultimately applying it. In such embodiments, the rules 170 can be implemented as simple rules or as complex rules. Complex rules may have more than conditions, and/or more than one consequents. Complex rules may be implemented as individual single rules with complex coding. Alternatively, a complex rule may be implemented in part by more than one simpler individual rules, which can have hierarchical relationships among them, e.g., from one rule's application or execution leading to another, and so on. As a result of the initial search, then, rules are found which, when applied, select that certain rule in the first place.

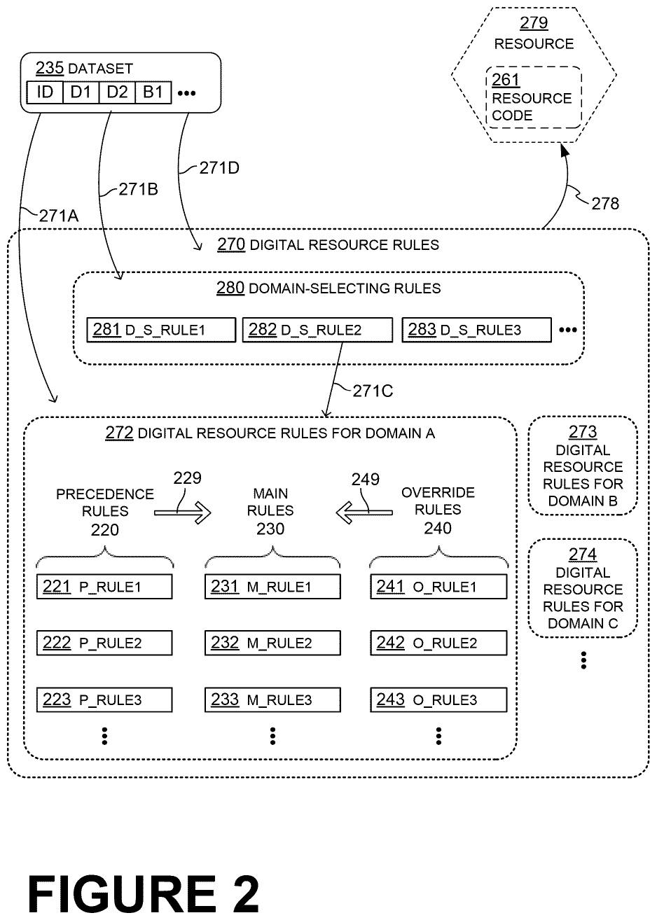

Referring now to FIG. 2, a dataset 235 may be similar to the dataset 135 of FIG. 1. In addition, a set 270 of digital resource rules is an example of digital resource rules, such as the digital resource rules 170 of FIG. 1. Similarly with FIG. 1, in FIG. 2 a resource 279 can be produced according to an arrow 278. The resource 279 may be similar to the resource 179, at least an aspect of which can be reported by the notification 136, and so on. Additionally, a resource code 261 can be produced similar to the resource code 161.

The set 270 of digital resource rules includes different subsets, to which the individual rules belong. In addition, there are hierarchical relationships among rules of different subsets, and/or of types. One of these individual rules is eventually selected and applied, while one or more of them may have been used for selecting it. That certain rule that is eventually selected is not pointed out in FIG. 2, as it was pointed out in FIG. 1, so as to not suggest that that certain rule necessarily belongs in any particular subset. In fact, that certain rule can be in any one of subsets of the digital resource rules 270.

In the example of FIG. 2, the set 270 includes a subset of domain-selecting rules 280. The set 270 also includes subsets 272, 273, and 274 each for digital resource rules for domains A, B, and C respectively. A domain for which a subset of resource rules is thus provided could be associated with the primary entity 193 of FIG. 1, another domain could be associated with the secondary entity 196, and so on.

In many embodiments, one of the domain-selecting rules of the subset 280 can be used to select which domain's rules should be applied. Then the certain one of the digital resource rule(s) can be selected from the digital resource rules of the selected domain. Then the resource 279 can be produced by applying the selected certain digital resource rule(s) to at least one of the dataset values of the dataset 235.

In this example, the subset of domain-selecting rules 280 includes rules D_S_RULE1 281, D_S_RULE2 282, and D_S_RULE3 283. One of these rules may be selected and used when more than one domain could be considered as eligible for its rules to apply. The rules of the subset 280, however, might not be necessary for embodiments where a single domain is considered or implied for one or more, or all of, the relationship instances. This can happen, for example, when it is known in advance that the primary entity 193 and every possible secondary entity are both associated with the same domain. Or, when it is planned that digital resource rules of only one domain will be considered, while any rules of any other domain will not be considered and will be disregarded.

Resource rules for individual domains are now described. Such rules need not be the same for each domain, or of the same type for each domain. The sample subset 272 of resource rules for domain A is now described in more detail. Its description can be similar for subsets for other domains, such as the subsets 273 and 274.

The subset 272 of resource rules includes different types of rules. In this example, the subset 272 includes precedence rules 220, main rules 230, and override rules 240. In this example, the precedence rules 220 include rules P_RULE1 221, P_RULE2 222, and P_RULE3 223. The main rules 230 include rules M_RULE1 231, M_RULE2 232, and M_RULE3 233. The override rules 240 include rules O_RULE1 241, O_RULE2 242, and O_RULE3 243. Any of the precedence rules 220, main rules 230, and override rules 240 may be used in a determination of a resource code, such as the resource code 261. Furthermore, a resource code, such as the resource code 261, may affect which of the precedence rules 220, main rules 230, and override rules 240 are applied to a relationship instance involving two or more domains.

In embodiments, one of the main rules 230 may ordinarily be selected as the certain digital resource rule, which in FIG. 1 is shown as rule D_R_RULE4 174. In other words, the certain digital resource rule could be, say, the main rule M_RULE2 232. In this example, although not always required, the different types of rules within the subset 272 further have different hierarchies among them.

For a first instance, one of the precedence rules 220 may indicate which one of the main rules 230 is to be selected, as generally indicated by an arrow 229. Or, the one of the precedence rules 220 that does apply may itself be the eventually selected certain digital resource rule, instead of indicating any one of the main rules 230.

For a second instance, even when one of the main rules 230 is thus indicated, one of the override rules 240 may still override the indication, as generally indicated by an arrow 249. In such cases, the one of the rules 240 that overrides may be the eventually selected certain digital resource rule, instead of one of the main rules 230. Or, one of the rules 240 overrides by indicating yet a different one of the main rules 230 to be selected instead, and so on.

In FIG. 2, sample arrows 271A, 271B and 271D begin from the dataset 235. These arrows suggest possible paths of the eventual selection of the certain rule, for ultimately producing the resource 279. These arrows are more detailed versions of the arrows 171 of FIG. 1. They are examples of possible arrows, and not all of them are necessarily used in every such determination.

According to the arrow 271A, the subset 272 is indicated. So, at least one of the rules of the subset 272 may initially be indicated as the certain rule, e.g., from one or more values of the dataset 235. The initially indicated rule can be the finally certain rule, or another intermediate rule which, in turn, will be used to select that certain rule.

According to the arrow 271B, at least one of the domain-selecting rules of the subset 280 may be invoked, from one or more values of the dataset 235.

According to an arrow 271C, the one of the rules of subset 280 that was invoked by the arrow 271B was the rule D_S_RULE2 282. And, the arrow 271C further indicates that the invoked rule points to the subset 272, instead of to the subsets 273 and 274. As such, the subset 272 of resource rules should be used for selecting the certain rule. This example has the same result, but from a different path, as the sample arrow 271A.

The arrow 271D is drawn to indicate that one or more of the values of the dataset 235 are received and processed by the finally selected certain rule, for producing the resource 279.

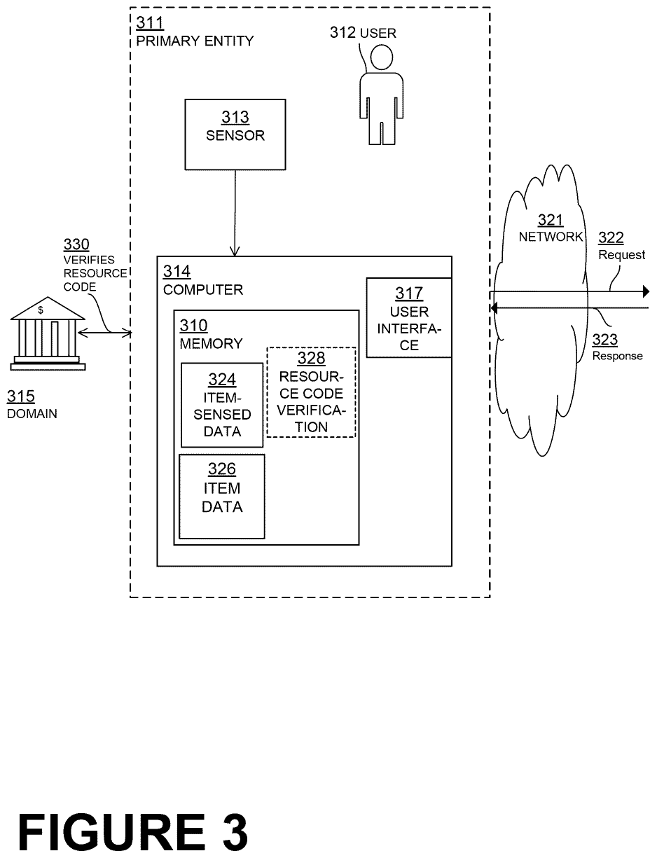

FIG. 3 is a diagram of sample aspects of a primary entity 311, according to various embodiments described herein. The primary entity 311 is similar to the primary entity 193, described above in connection with FIG. 1. The primary entity 311 includes a user 312, a computer 314, and a sensor 313. The user 312, the sensor 313 and the computer 314 may be similar to the user 192, sensor 110, and computer system 110, respectively.

Furthermore, the primary entity 311 may utilize a network 321 to transmit requests, such as the request 322, and to receive responses, such as the response 323. The network 321, request 322, and response 323, are similar to the network 188, request 184, and response 187, respectively. Thus, the primary entity 311 may communicate with an OSP, such as the OSP 198, via the network 321.

The primary entity 311 may interact with a domain 315, as indicated by the connector 330. The primary entity 311 may interact with the domain 315, such as through a network, to verify one or more resource codes as indicated by the connector 330.

The computer 314 includes memory 310 and a user interface 317. The computer 314 may use the user interface 317 to display information to a user, such as the user 312, receive input from a user, display output to a user, or to perform other functions that allow the user to view or interact with programs or data. For example, in some embodiments, the computer 314 receives one or more prompts from an OSP, such as the OSP 198, displays the prompts to the user 312 via the user interface 317, and receives input regarding the prompts from the user 312 via the user interface 317.

The memory 310 may store programs or data (not shown), such as the programs 131 and data 138 described above in connection with FIG. 1. The memory 310 stores data relevant to the operation of the systems described herein, such as item-sensed data 324 and item data 326.

The item-sensed data 324 may be similar to the sensed data 112 described above in connection with FIG. 1. The computer 314 may receive item-sensed data 324 from a sensor 313.

The item data 326 may include data describing one or more items. The one or more items may be or include: items that are detected or sensed by a computer 314 or sensor 313; items that are included in a repository of items maintained by, accessed by, used by, or otherwise associated with the primary entity 311; or other items. The item data 326 may be or include: data generated from item-sensed data 324; data generated from other item data; data included in a repository of item data maintained by, accessed by, used by, or otherwise associated with the primary entity 311; or other data describing an item.

In some embodiments, the memory 310 additionally stores data related to resource code verification 328. The resource code verification 328 includes instructions, data, programs, etc., used by the computer 314 to verify a resource code with a domain, such as a domain 315. For example, the resource code verification 328 may include data indicating a web portal associated with a domain through which resource code verification requests may be made. In such an example, the computer 314 may receive an indication of a resource code from an OSP, such as the OSP 198, and may then verify the resource code by using the resource code verification 328.

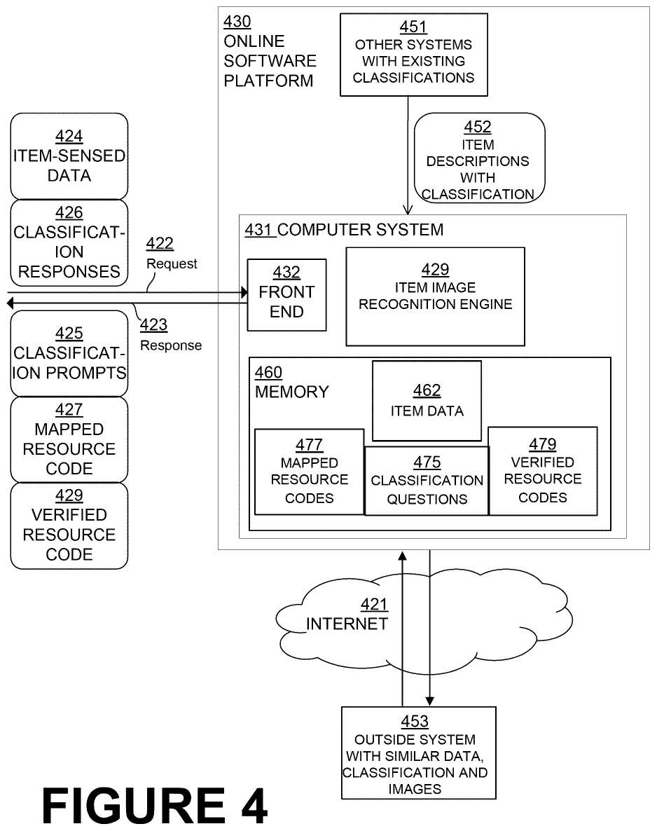

FIG. 4 is a diagram of sample aspects of an online software platform 430, according to various embodiments described herein. The online software platform 430 (“OSP 430”) is similar to the OSP 198, described above in connection with FIG. 1. The OSP 430 includes various systems, such as systems with existing classifications 451 and a computer system 431.

The systems with existing classifications 451 are, or include, other systems associated with the OSP 430, such as repositories of item data, repositories of item classification data, systems used for other types of item classifications, systems associated with one or more entities that have already classified one or more items, or other systems that may use or include item classifications. The OSP 430 may cause one or more of the systems with existing classifications to transmit one or item descriptions with classifications 452 to the computer system 431. For example, the systems with existing classifications 451 may have already classified an item included in a request to the computer system 431, and the OSP 430 may cause the classification of the item to be transmitted to the computer system 431. In this example, the computer system 431 is able to conserve processing, memory, and other computing resources by using the received classification of the item, such as by using the classification as a starting point to classify the item, using the classification outright, etc.

The computer system 431 includes a front end 432, an item image recognition engine 429, and a memory 460. The computer system 431 is similar to the computer system 195 described above in connection with FIG. 1. The front end 432 may be or include an API or other interface for the computer system 431 to receive or transmit requests and responses from a primary entity, such as the primary entity 193 described above in connection with FIG. 1.

In an example, the computer system 431 receives a request 422 that includes item-sensed data 424. The computer system 431 processes the item-sensed data 424 and determines it needs more information to classify an item indicated by the item-sensed data 424. The computer system 431 transmits a response 423 to the primary entity that includes classification prompts 425 to trigger classification responses 426 from the primary entity in a second request 422. The computer system 431 determines a mapped resource code 427 based on the classification responses and item data, and transmits the mapped resource code 427 to the primary entity.

The OSP 430 may utilize the Internet 421, or another network, to communicate with one or more of the primary entity, a secondary entity, or other outside systems such as the outside system 453. The outside system 453 may be another OSP, a system associated with a primary entity, a system associated with a secondary entity, a system associated with a domain, other systems that may be used to classify items based on resource codes, or other systems that may be used to identify items based on an image. For example, the computer system 431 may verify the resource code with a domain in a process similar to the primary entity 311 verifying a resource code with the domain 315 described above in connection with FIG. 3 to obtain a verified resource code 429. The computer system 431 may verify the resource code with the domain by accessing a system associated with the domain. The verified resource code 429 may be transmitted via the response 423.

The front end 432 may be a web server, web engine, or other interface that interacts with a browser operated by a client computing device, such as the computer system 190 described above in connection with FIG. 1.

The memory 460 of the computer system 431 includes item data 462, classification questions 475, mapped resource codes 477, and verified resource codes 479. The item data 462 may be similar to the item data 326. The mapped resource codes 477 include data describing resource codes which have been mapped to items by classifying the items. The verified resource codes 479 include data describing resource codes which have been verified with a domain to be mapped to items.

The classification questions 475 include one or more questions or prompts that the computer system 431 may transmit to a primary entity. Answers to the classification questions 475 may be used by the computer system 431 to determine a classification for an item and map a resource code to the item based on the classification.

The computer system 431 uses the item image recognition engine 429 as part of determining a classification or resource code for an item, such as by: identifying an item indicated by item-sensed data; determining, generating, synthesizing, or otherwise creating prompts for classifying an item; or accessing or using other processes, data, systems, techniques, etc. for identifying an item or generating a classification or resource code for an identified item. Although the item image recognition engine 429 uses image data included in item-sensed data, such as item-sensed data 424, embodiments are not so limited, and data of other types indicating an item, such as text data, infrared data, sound data, or any other data which may describe an item.

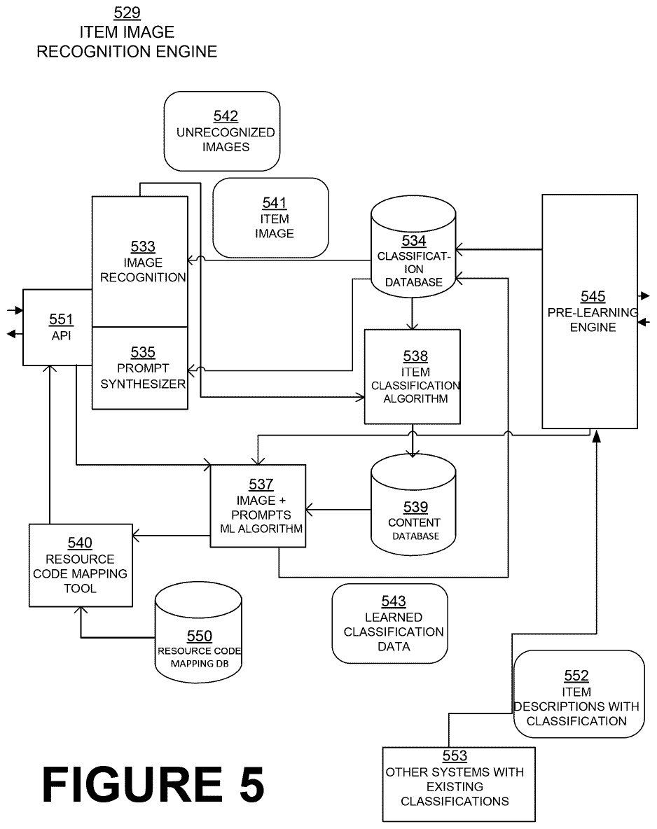

FIG. 5 is a diagram of sample aspects of an item recognition engine 529, according to various embodiments described herein. The item image recognition engine 529 may be the item recognition engine 429 described above in connection with FIG. 4. The item image recognition engine 529 includes an API 551 which may be used by an OSP, such as the OSP 430, a computer system, such as the computer system 431, or other processes or systems which may be used to determine a classification or resource code for an item.

The API 551 passes data, such as item-sensed data, to and receives data, such as item identity data or item classification data, from an image recognition process 533. The image recognition process 533 applies the item-sensed data to an image recognition algorithm, such as an artificial intelligence or machine learning model, to identify an item in the item-sensed data. The image recognition process 533 may pass an identified item image 541 or an unrecognized item image 542 to the item classification algorithm 538. Data associated with the identity of the item is passed from the image recognition process 533 to the item classification algorithm 538. In some embodiments, the image recognition algorithm 533 may be improved or re-trained based on classified images stored in the classification database 534.

The item classification algorithm 538 classifies an item based on item identity data, such as item identity data received from the image recognition process 533. The item classification algorithm 538 may receive data from a classification database 534 related to previous item classifications. The item classification algorithm 538 may transmit data regarding the classification of the item and the identity of the item to a content database 539.

The content database 539 includes data regarding the classification of items and item identity data regarding the classified items. The data included in the content database 539 may be used to re-train or otherwise improve an artificial intelligence or machine learning model used to classify items based on item identity data. In some embodiments, the content database 539 additionally includes data indicating one or more prompts that may be used to classify items.

The API 551 receives data from a prompt synthesizer 535. The prompt synthesizer 535 receives data from the classification database 534 to generate prompts used to determine the identity or classification of an item. The prompt synthesizer 535 transmits prompts to a computer system or OSP by the API 551. The API 551 transmits answers to the prompts to an image and prompts machine learning algorithm, such as the image and prompts machine learning algorithm 537.

The image and prompts machine learning algorithm 537 is applied to item identity data, classification data, and the answers to prompts to generate one or more resource codes describing the classification of an item. The output of the image and prompts machine learning algorithm 537 is transmitted to a resource code mapping tool, such as the resource code mapping tool 540. The image and prompts machine learning algorithm 537 transmits learned classification data, such as learned classification data 543 to the classification database 534. Learned classification data includes one or more of: data regarding the classification of an item; data regarding one or more resource codes generated for an item; item identity data; classification data; answers to prompts; or other data related to generating a resource code for an item. In some embodiments, the image and prompts machine learning algorithm 537 determines whether answers to additional prompts are needed in order to generate a resultant resource code. In such embodiments, the image and prompts machine learning algorithm 537 receives additional answers to prompts from the API 551.

The resource code mapping tool 540 maps a resource code to the item based on a classification and one or more resource codes received from the image and prompts machine learning algorithm 537. The resource code mapping tool 540 may receive data associated with resource codes from a resource code mapping database 550. The resource code mapping database 550 includes data associated with resource codes that have been mapped to classified items. The resource code mapping tool 540 transmits the mapped resource code to the API 551.

A pre-learning engine 545 transmits pre-learned data to the classification database 534 and to the image and prompts machine learning algorithm 537 to assist in the classification and identification of items. The pre-learning engine 545 may receive data from other systems with existing classifications 553, such as item descriptions with classification 552. The other systems with existing classifications 553 may be similar to the other systems with existing classifications 451, described above in connection with FIG. 4. The item descriptions with classification 552 may be similar to the item description with classification 452, described above in connection with FIG. 4. The pre-learning engine 545 may use the data received from the other systems with existing classifications to train the various algorithms and machine learning models included in the item image recognition engine 529.

In some embodiments, the pre-learning engine 545, for learning purposes, may receive data from within the item image recognition engine 529 or within the OSP 430, for example in consort with the item image recognition engine 529, when relevant data is updated by the image recognition engine 529. In some embodiments, the image recognition process 533 may additionally provide the item image 541 or updated item data and image (e.g., updated item data and images about the unrecognized images 542) to the pre-learning engine 545 directly, or indirectly via one or more other components of the item image recognition engine 529, such as via the item classification algorithm 538, the machine learning algorithm 537, and so on. Updated data (e.g., updated images and/or item data) may also be utilized by the pre-learning engine 545 to train the engine's various algorithms and machine learning models.

In some embodiments, the pre-learning engine 545 may receive data from other outside sources, such as the outside system with similar data, classification and images 453 described above in connection with FIG. 4.

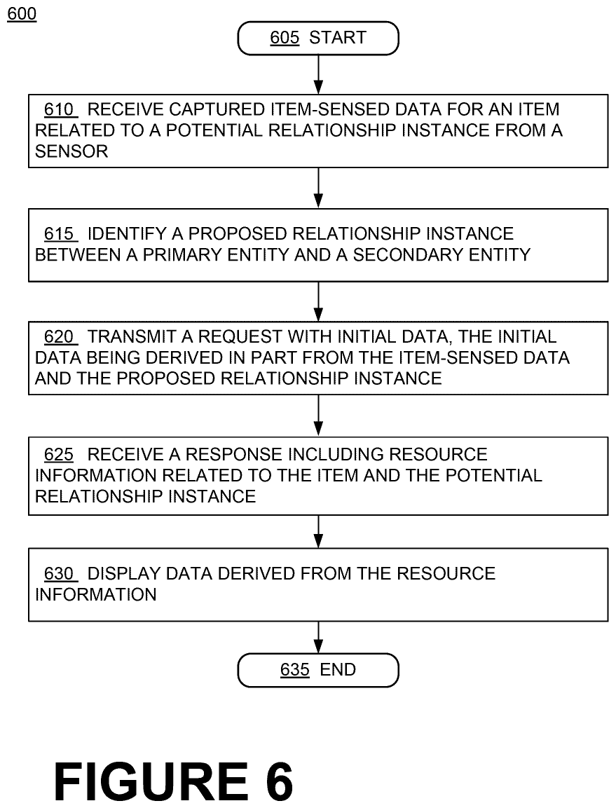

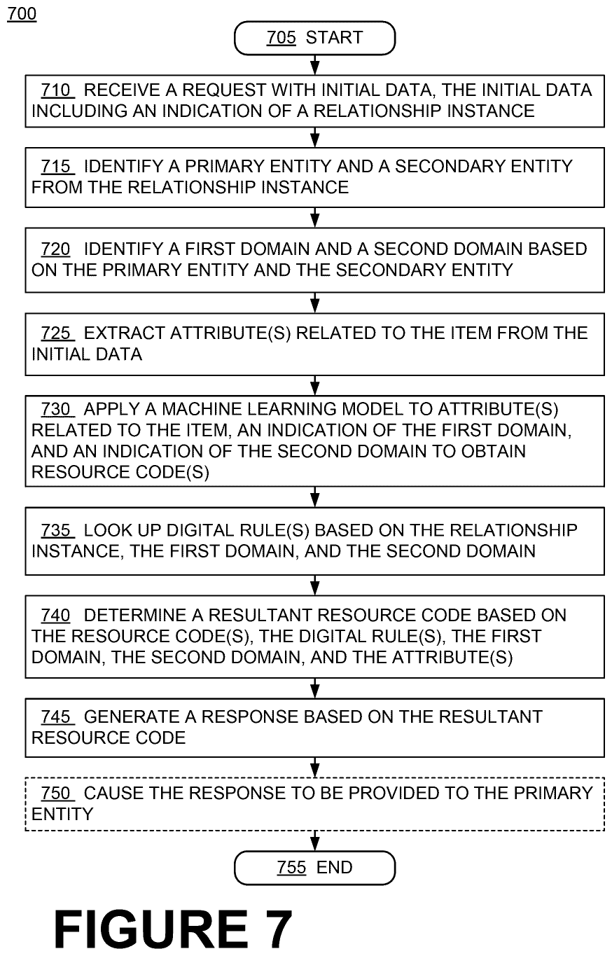

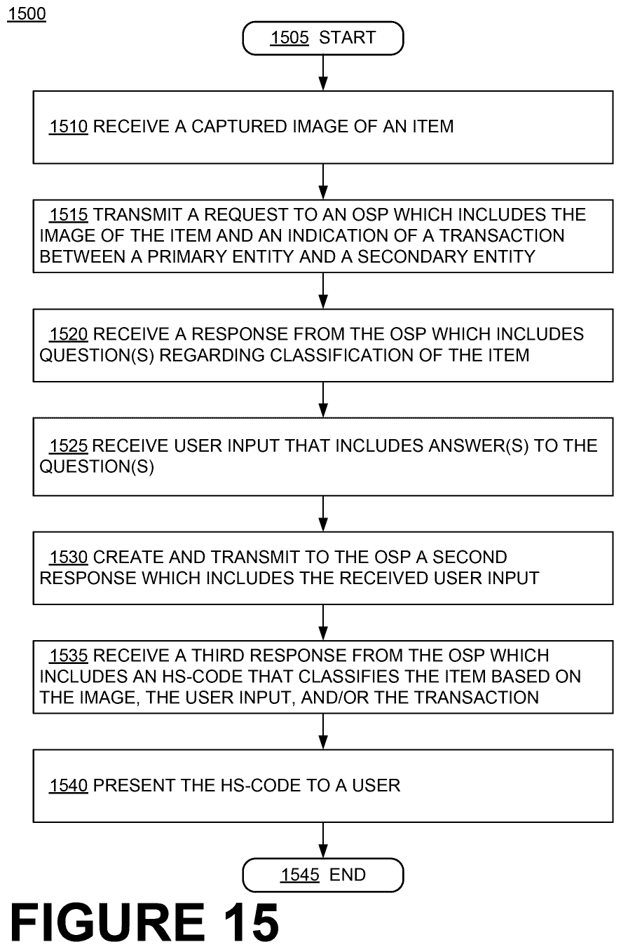

In the present example, the operations and methods described with reference to the flowcharts illustrated in FIGS. 6 and 15 are described as being performed by the computer system 190 or computer system 1490. The operations and methods described with reference to the flowcharts illustrated in FIGS. 7-12B and 16-17 are described as being performed by the OSP 198 or OSP 1498. Although the operations and methods described with the flowcharts illustrated in FIGS. 6-12B and 15-17 are described as being performed by the computer system 190, computer system 1490, OSP 198 or OSP 1498, embodiments are not so limited, and any of the operations or methods may be performed by any of the computer system 190, computer system 1490, OSP 198 or OSP 1498.

FIG. 6 is a flowchart for illustrating a sample method 600 for receiving data derived from item-sensed data related to a potential relationship instance, according to various embodiments described herein.

The method 600 starts at 605.

At 610, the computer system 190 receives from a sensor captured item-sensed data for at least one item related to a potential relationship instance.

At 615, the computer system 190 identifies a proposed relationship instance between a primary entity and a secondary entity.

At 620, the computer system 190 transmits a request with initial data, the initial data being derived in part from the item-sensed data and the proposed relationship instance.

At 625, the computer system 190 receives a response including resource information related to the item and the potential relationship instance. The resource information may include one or more of: a classification of the at least one item, a resource code mapped to the at least one item, or other resource information related to the item and the potential relationship instance.

At 630, the computer system 190 displays data derived from the resource information. The data derived from the resource information may include data related to a resource code mapped to, or a classification of, the item.

The method ends at 635.

FIG. 7 is a flowchart for illustrating a sample method 700 for generating a resource code for an item, according to various embodiments described herein.

The method 700 starts at 705.

At 710, the OSP 198 receives a request with initial data, the initial data including an indication of a relationship instance.

At 715, the OSP 198 identifies a primary entity and a secondary entity from the relationship instance.

At 720, the OSP 198 identifies a first domain and a second domain based on the primary entity and the secondary entity.

At 725, the OSP 198 extracts one or more attributes related to the item from the initial data.

At 730, the OSP 198 applies a machine learning model to the one or more attributes related to the item, the indication of the first domain, and the indication of the second domain to obtain one or more resource codes.

At 735, the OSP 198 looks up one or more digital rules based on the relationship instance, the first domain, and the second domain.

At 740, the OSP 198 determines a resultant resource code based on the one or more resource codes, the one or more digital rules, the first domain, the second domain, and the one or more attributes.

At 745, the OSP 198 generates a response based on the resultant resource code.

Optionally, at 750, the OSP 198 causes the response to be provided to the primary entity.

### At 755, the Method 700 Ends.

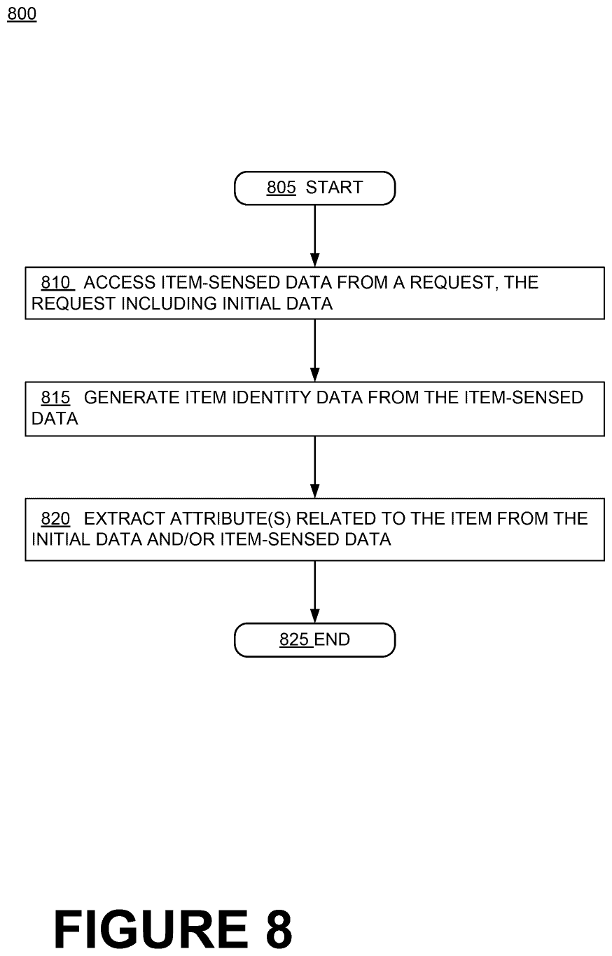

FIG. 8 is a flowchart for illustrating a sample method 800 for generating item identity data to extract attributes related to an item, according to various embodiments described herein. In some embodiments, the OSP 198 performs the method 800 as part of performing act 725 described above in connection with FIG. 7.

The method 800 starts at 805.

At 810, the OSP 198 accesses item-sensed data from a request, the request including initial data.

At 815, the OSP 198 generates item identity data from the item-sensed data. In some embodiments, where the item-sensed data includes an image, the OSP 198 generates the item identity data by applying an image recognition algorithm, such as via the item image recognition engine 529 described above in connection with FIG. 5, to the item-sensed data.

At 820, the OSP 198 extracts attributes related to the item from at least one of: the initial data and the item-sensed data.

At 825, the method 800 ends.

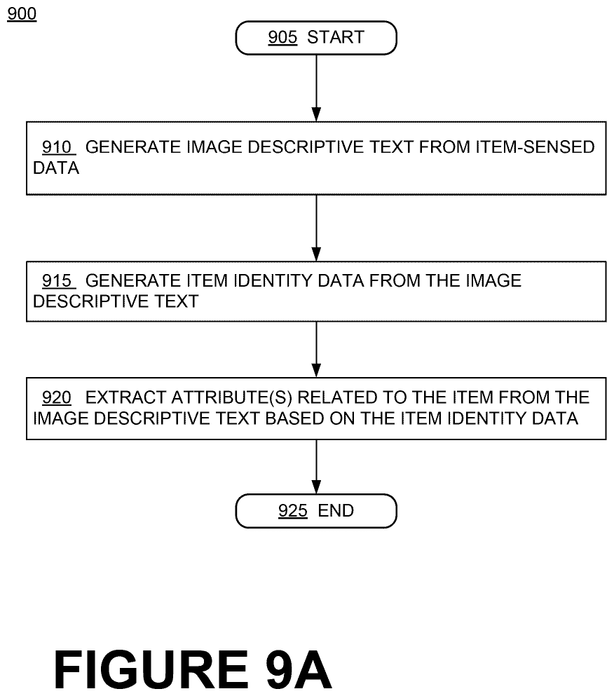

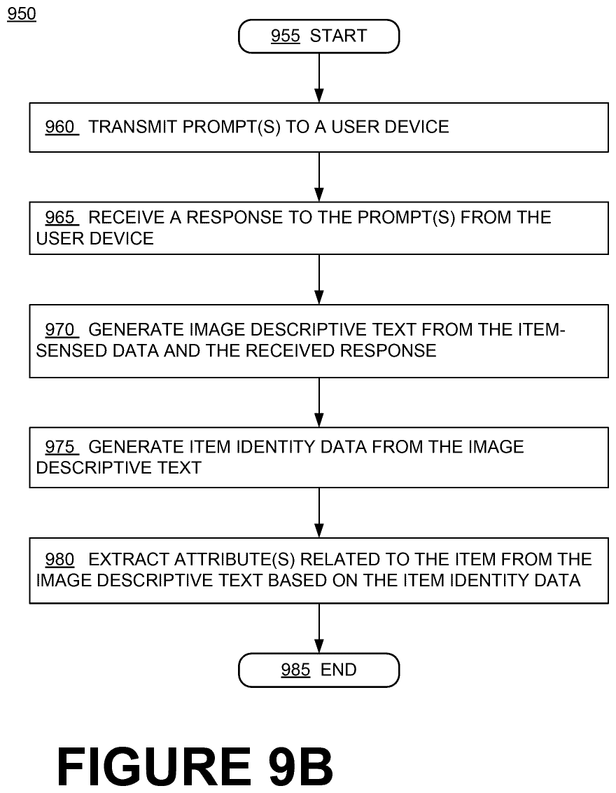

FIG. 9A is a flowchart for illustrating a sample method 900 to extract attributes related to an item based on image descriptive text, according to various embodiments described herein. In some embodiments, attributes relate to the item itself. In some embodiments the attributes may include attributes associated with the item for context or further specificity about the item. In some embodiments, the OSP 198 performs the method 900 as part of performing act 725 described above in connection with FIG. 7.

The method 900 starts at 905.

At 910, the OSP 198 generates image descriptive text from item-sensed data. In some embodiments, the OSP 198 generates the image descriptive text by applying an artificial intelligence or machine learning model trained to output text describing an image based on item-sensed data to the item-sensed data.

At 915, the OSP 198 generates item identity data from the image descriptive text. In some embodiments, the OSP 198 performs one or more of acts 910 and 915 via an item image recognition engine, such as the item image recognition engine 529 described above in connection with FIG. 5.

At 920, the OSP 198 extracts one or more attributes related to the item from the image descriptive text based on the item identity data. For example, the OSP 198 may identify one or more words or phrases related to the item based on the item identity data. Thus, in such an example, the OSP 198 is able to filter out text that is not related to the item, such as text describing the environment around the item, and prevent unrelated text from influencing the extracted attributes.

In some embodiments, at 920, the OSP 198 receives additional text data from a computer system associated with a primary entity that describes the item. In such embodiments, attributes related to the item may be extracted based on the additional text data, the image descriptive text, and the item identity data. In some embodiments, the additional text data includes one or more of: a description of the item, a user manual or instructions for use of the item, or other text data related to an item.

At 925, the method 900 ends.

FIG. 9B is a flowchart for illustrating another sample method 950 to extract attributes related to an item based on image descriptive text, according to various embodiments described herein. In some embodiments, the OSP 198 performs the method 950 as part of performing act 725 described above in connection with FIG. 7.

The method 950 starts at 955.

At 960, the OSP 198 transmits one or more prompts to a user device. In some embodiments, the OSP 198 generates the one or more prompts based on item-sensed data, such as by using the item image recognition engine 529.

At 965, the OSP 198 receives a response to the prompts from the user device.

At 970, the OSP 198 generates image descriptive text from item-sensed data and the received response. The OSP 198 may perform act 970 in a similar manner to act 910 described above in connection with FIG. 9A.

At 975, the OSP 198 generates item identity data from the image descriptive text. The OSP 198 may perform act 975 in a similar manner to act 915 described above in connection with FIG. 9A.

At 980, the OSP 198 extracts one or more attributes related to the item from the image descriptive text based on the item identity data. The OSP 198 may perform act 980 in a similar manner to act 920 described above in connection with FIG. 9A.

At 985, the method 900 ends.

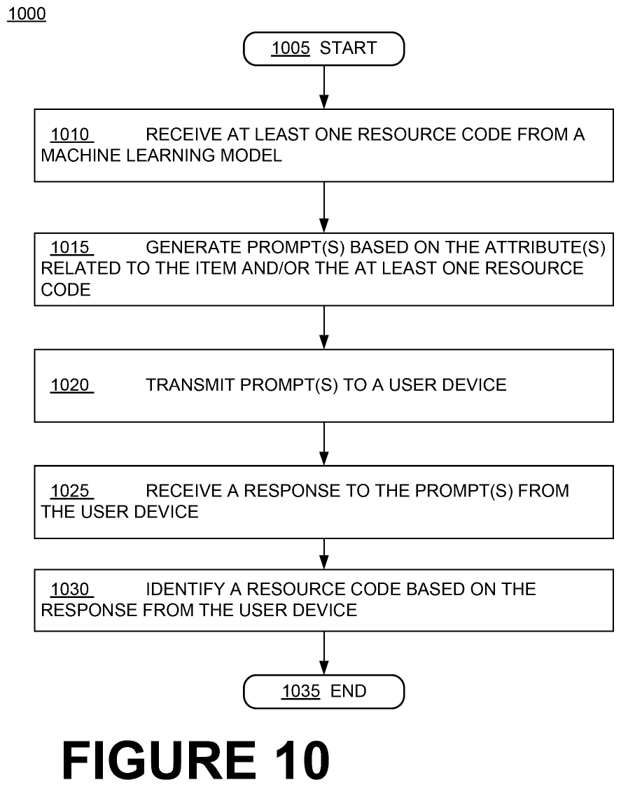

FIG. 10 is a flowchart for illustrating another sample method 1000 to identify a resource code for an item based on answers to prompts, according to various embodiments described herein. In some embodiments, the OSP 198 performs the method 1000 as part of performing act and 740 described above in connection with FIG. 7.

The method 1000 starts at 1005.

At 1010, the OSP 198 receives at least one resource code for an item from a machine learning model. In some embodiments, the OSP 198 receives the at least one resource code as a result of performing act 730 described above in connection with FIG. 7.

At 1015, the OSP 198 generates one or more prompts based on at least one of: one or more attributes related to the item and the at least one resource code. In some embodiments, the OSP 198 generates the one or more prompts via a prompt synthesizer, such as the prompt synthesizer 535 described above in connection with FIG. 5. For example, when the machine learning model outputs multiple resource codes for an item, the OSP 198 may determine which information is needed to determine which resource code should be assigned to an item based on the multiple output resource codes. In this example, the OSP 198 generates the one or more prompts based on the information needed to determine which resource code should be assigned to the item.

At 1020, the OSP 198 transmits the one or more prompts to a user device associated with a primary entity, such as the computer system 190 described above in connection with FIG. 1.

At 1025, the OSP 198 receives a response to the one or more prompts from the user device.

At 1030, the OSP 198 identifies a resource code for the item based on the response received from the user device. In some embodiments, the OSP 198 identifies the resource code based on the identified attributes related to the item, the response received from the user device, and the at least one resource code.

At 1035 the process 1000 ends.

In some embodiments, the OSP 198 determines whether to perform the process 1000 based on the output of the machine learning model. For example, if a confidence score of the machine learning model's output exceeds a threshold level, the OSP 198 may determine that the process 1000 should be performed to obtain a resultant resource code. In such an example, the resultant resource code may be a resource code that was not output by the machine learning model. In another example, if the machine learning model outputs multiple resource codes which each have confidence scores that exceed a threshold level, the OSP 198 may determine that the process 1000 should be performed to determine which of the multiple resource codes, if any, are the resultant resource code.

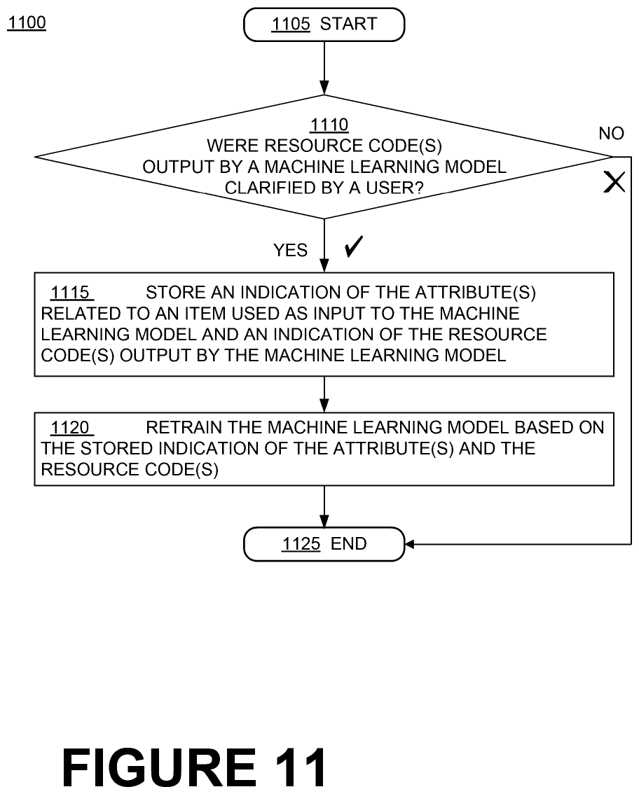

FIG. 11 is a flowchart for illustrating another sample method 1100 to identify data for retraining a machine learning model to output one or more resource codes, according to various embodiments described herein. In some embodiments, the OSP 198 performs the method 1100 periodically, thereby causing the machine learning model used to output one or more resource codes to improve.

The method 1100 starts at 1105.

At 1110, the OSP 198 determines whether one or more resource codes output by a machine learning model were clarified by a user. The OSP 198 may make this determination by determining whether one or more prompts were generated for the one or more resource codes, such as by using the method 950 or method 1000 described above in connection with FIGS. 9B and 10 respectively. If the OSP 198 determines that one or more resource codes were not clarified by a user, the process 1100 proceeds to 1125 where the process 1100 ends. Otherwise, the process 1100 proceeds to 1115.

At 1115, the OSP 198 stores an indication of one or more attributes related to an item that were used as input to the machine learning model and an indication of the one or more resource codes output by the machine learning model. At 1115, the OSP 198 may also store an indication of one or more prompts that were used to clarify the one or more resource codes.

At 1120, the OSP 198 re-trains the machine learning model based on at least the stored indication of the one or more attributes and the one or more resource codes. In some embodiments, at 1120, the OSP 198 re-trains the machine learning model based on the indication of one or more prompts, the one or more attributes, and the one or more resource codes.

At 1125, the process 1100 ends.

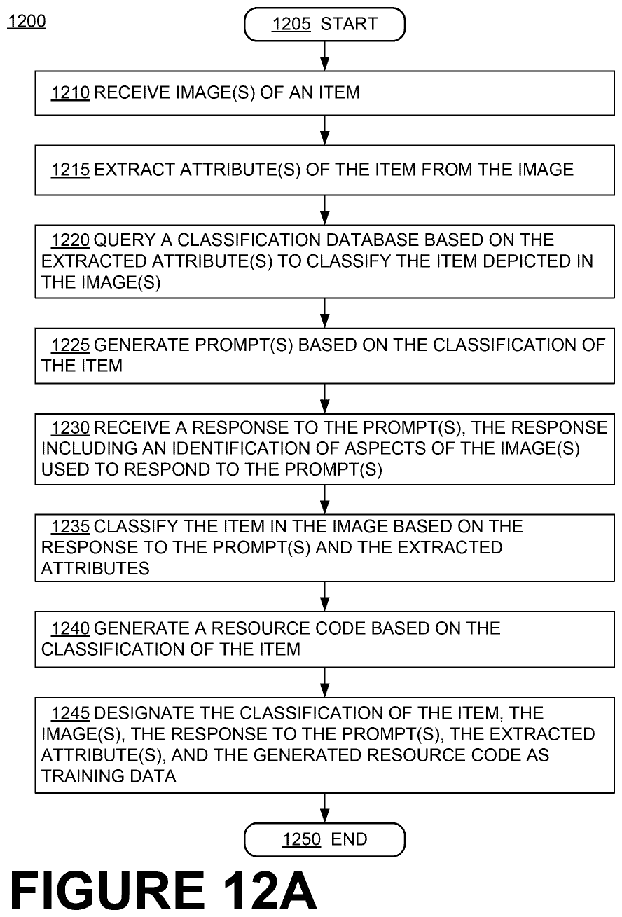

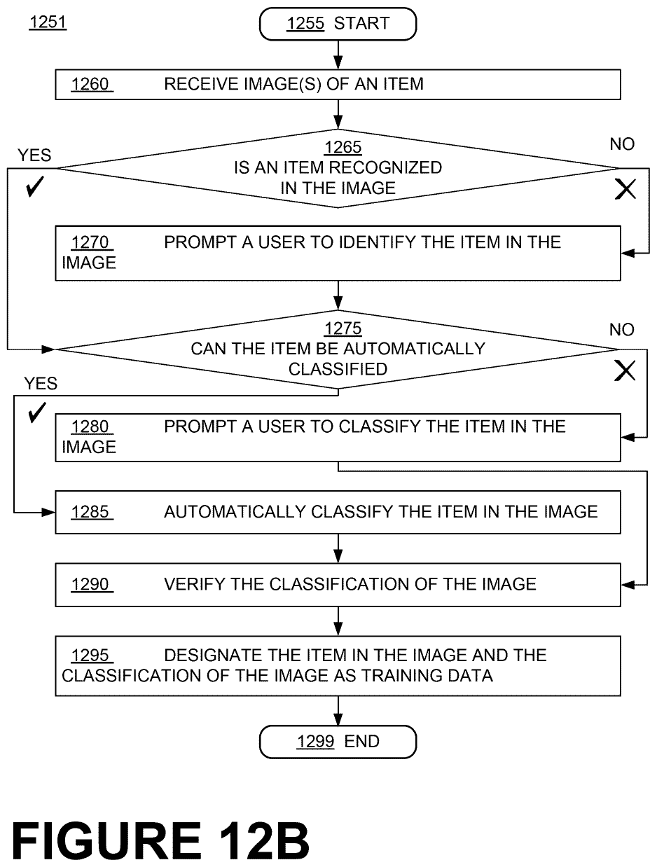

FIG. 12A is a flowchart for illustrating another sample method 1200 to obtain training data to train, or re-train, a machine learning model that outputs one or more resource codes, according to various embodiments described herein.

The method 1200 begins at 1205.

At 1210, the OSP 198 receives one or more images of an item.

At 1215, the OSP 198 extracts one or more attributes of the item from the image. In some embodiments the attributes may include attributes associated with the item for context or further specificity about the item. At 1220, the OSP 198 queries a classification database based on the extracted one or more attributes to classify the item depicted in the one or more images. The classification database queried by the OSP 198 may be the classification database 534, described above in connection with FIG. 5.

At 1225, the OSP 198 generates one or more prompts based on the classification of the item. The OSP 198 may generate the one or more prompts via the prompt synthesizer 535, described above in connection with FIG. 5.

At 1230, the OSP 198 receives a response to the one or more prompts, including an identification of aspects of the one or more images used to respond to the one or more prompts. For example, the identified aspects may be aspects that a user responding to the prompts has identified as being usable to identify or classify an item in an image.

At 1235, the OSP 198 classifies the item in the image based on the response to the one or more prompts and the extracted attributes. In some embodiments, classifying the item includes one or more of: determining a type of the item, determining an identity of an item, determining a function of the item, or determining other aspects of the item.

At 1240, the OSP 198 generates a resource code for the item based on the classification of the item. The OSP 198 may generate the resource code in a similar manner to acts 730, 735, and 740, described above in connection with FIG. 7.

At 1245, the OSP 198 designates the classification of the item, the one or more images, the response to the one or more prompts, the extracted one or more attributes, and the generated resource code as training data for a machine learning model configured to output a resource code.

At 1250, the process 1200 ends.

FIG. 12B is a flowchart for illustrating another sample method 1251 to obtain training data to train, or re-train, a machine learning model to generate resource codes, according to various embodiments described herein.

The process 1251 begins at 1255.

At 1260, the OSP 198 receives one or more images of an item.

At 1265, the OSP 198 determines whether an item is recognized in the one or more images. In some embodiments, the OSP 198 determines whether the item is recognized by identifying the item via an image recognition engine, such as the item image recognition engine 529, and accessing a repository of data associated with recognized items. If the item is not recognized in the image, the method 1251 proceeds to 1270, otherwise, the process 1251 proceeds to 1275.

At 1270, the OSP 198 prompts a user to identify the item in the image.

At 1275, the OSP 198 determines whether the identified item can be automatically classified. In some embodiments, the OSP 198 determines whether the item can be automatically classified by determining whether other similar items have been automatically classified, such as by determining whether similar items are included in a content database 539 or a classification database 534, each described above in connection with FIG. 5. If the item can be automatically classified, the method 1251 proceeds to 1285, otherwise, the method 1251 proceeds to 1280.

At 1280, the OSP 198 prompts a user to classify the item in the image. In some embodiments, the user that is prompted to classify the item is one or more of: a user associated with a primary entity, a user associated with a domain, and a user associated with the OSP 198.

At 1285, the OSP 198 automatically classifies the item in the image. The OSP 198 may automatically classify the item via an item classification algorithm, such as the item classification algorithm 538.

At 1290, the OSP 198 verifies the classification of the image. In some embodiments, the OSP 198 verifies the classification of the image by transmitting the image and the classification of the image to a user for verification. In some embodiments, the OSP 198 verifies the classification of the image by accessing one or more systems associated with a domain.

At 1295, the OSP designates the image and the classification of the item in the image as training data.

At 1299, the process 1251 ends.

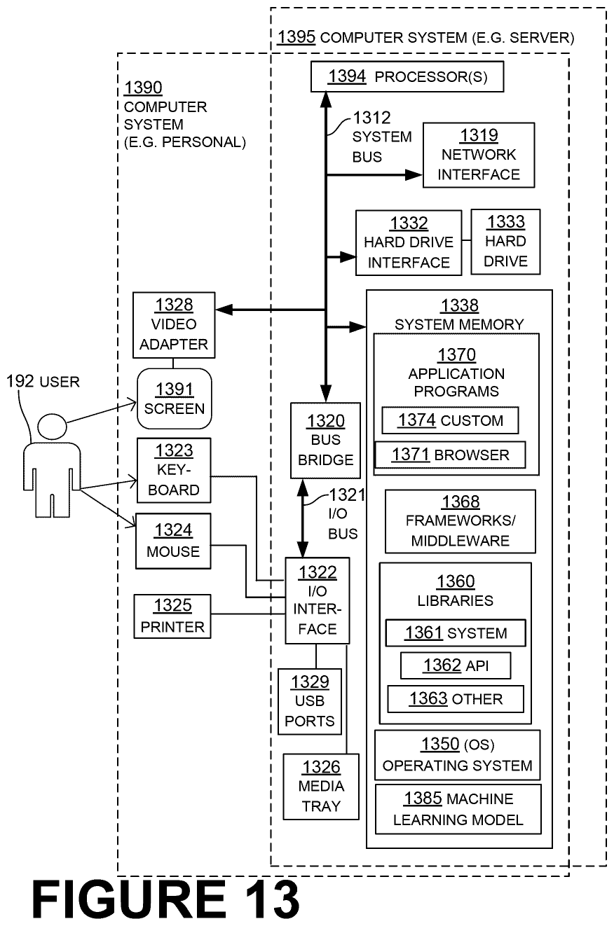

FIG. 13 shows details for a sample computer system 1395 and for a sample computer system 1390. The computer system 1395 may be a server, while the computer system 1390 may be a personal device, such as a personal computer, a desktop computer, a personal computing device such as a laptop computer, a tablet computer, a mobile phone, and so on. Either type may be used for the computer system 195 and 190 of FIG. 1, and/or a computer system that is part of OPF 189.

The computer system 1395 and the computer system 1390 have similarities, which FIG. 13 exploits for purposes of economy in this document. It will be understood, however, that a component in the computer system 1395 may be implemented differently than the same component in the computer system 1390. For instance, a memory in a server may be larger than a memory in a personal computer, and so on. Similarly, custom application programs 1374 that implement embodiments may be different, and so on.

The computer system 1395 includes one or more processors 1394. The processor(s) 1394 are one or more physical circuits that manipulate physical quantities representing data values. The manipulation can be according to control signals, which can be known as commands, op codes, machine code, etc. The manipulation can produce corresponding output signals that are applied to operate a machine. As such, one or more processors 1394 may, for example, include a Central Processing Unit (CPU), a Reduced Instruction Set Computing (RISC) processor, a Complex Instruction Set Computing (CISC) processor, a Graphics Processing Unit (GPU), a Digital Signal Processor (DSP), a Field-Programmable Gate Array (FPGA), an Application Specific Integrated Circuit (ASIC), any combination of these, and so on. A processor may further be a multi-core processor having two or more independent processors that execute instructions. Such independent processors are sometimes called “cores”.

A hardware component such as a processor may also include programmable logic or circuitry that is temporarily configured by software to perform certain operations. For example, a hardware component may include software executed by a general-purpose processor or another type of programmable processor. Once configured by such software, hardware components become specific machines, or specific components of a machine, uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

As used herein, a “component” may refer to a device, physical entity or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. The hardware components depicted in the computer system 1395, or the computer system 1390, are not intended to be exhaustive. Rather, they are representative, for highlighting essential components that can be used with embodiments.

The computer system 1395 also includes a system bus 1312 that is coupled to the processor(s) 1394. The system bus 1312 can be used by the processor(s) 1394 to control and/or communicate with other components of the computer system 1395.

The computer system 1395 additionally includes a network interface 1319 that is coupled to system bus 1312. Network interface 1319 can be used to access a communications network, such as the network 188. Network interface 1319 can be implemented by a hardware network interface, such as a Network Interface Card (NIC), wireless communication components, cellular communication components, Near Field Communication (NFC) components, Bluetooth® components such as Bluetooth® Low Energy, Wi-Fi® components, etc. Of course, such a hardware network interface may have its own software, and so on.

The computer system 1395 also includes various memory components. These memory components include memory components shown separately in the computer system 1395, plus cache memory within the processor(s) 1394. Accordingly, these memory components are examples of non-transitory machine-readable media. The memory components shown separately in the computer system 1395 are variously coupled, directly or indirectly, with the processor(s) 1394. The coupling in this example is via the system bus 1312.

Instructions for performing any of the methods or functions described in this document may be stored, completely or partially, within the memory components of the computer system 1395, etc. Therefore, one or more of these non-transitory computer-readable media can be configured to store instructions which, when executed by one or more processors 1394 of a host computer system such as the computer system 1395 or the computer system 1390, can be designed to or programmed to cause the host computer system to perform operations according to embodiments. The instructions may be implemented by computer program code for carrying out operations for aspects of this document. The computer program code may be written in any combination of one or more programming languages, including an object-oriented programming language such as Java, Smalltalk or the like, and/or conventional procedural programming languages, such as the “C” programming language or similar programming languages such as C++, C Sharp, etc.

The memory components of the computer system 1395 include a non-volatile hard drive 1333. The computer system 1395 further includes a hard drive interface 1332 that is coupled to the hard drive 1333 and to the system bus 1312.

The memory components of the computer system 1395 include a system memory 1338. The system memory 1338 includes volatile memory including, but not limited to, cache memory, registers and buffers. In embodiments, data from the hard drive 1333 populates registers of the volatile memory of the system memory 1338.

In some embodiments, the system memory 1338 has a software architecture that uses a stack of layers, with each layer providing a particular functionality. In this example the layers include, starting from the bottom, an Operating System (OS) 1350, libraries 1360, frameworks/middleware 1368 and application programs 1370, which are also known more simply as applications 1370. Other software architectures may include less, more or different layers. For example, a presentation layer may also be included. For another example, some mobile or special purpose operating systems may not provide a frameworks/middleware 1368.

The OS 1350 may manage hardware resources and provide common services. The libraries 1360 provide a common infrastructure that is used by the applications 1370 and/or other components and/or layers. The libraries 1360 provide functionality that allows other software components to perform tasks more easily than if they interfaced directly with the specific underlying functionality of the OS 1350. The libraries 1360 may include system libraries 1361, such as a C standard library. The system libraries 1361 may provide functions such as memory allocation functions, string manipulation functions, mathematical functions, and the like.

In addition, the libraries 1360 may include API libraries 1362 and other libraries 1363. The API libraries 1362 may include media libraries, such as libraries to support presentation and manipulation of various media formats such as MPREG4, H.264, MP3, AAC, AMR, JPG, and PNG. The API libraries 1362 may also include graphics libraries, for instance an OpenGL framework that may be used to render 2D and 3D in a graphic content on the screen 1391. The API libraries 1362 may further include database libraries, for instance SQLite, which may support various relational database functions. The API libraries 1362 may additionally include web libraries, for instance WebKit, which may support web browsing functionality, and also libraries for applications 1370.

The frameworks/middleware 1368 may provide a higher-level common infrastructure that may be used by the applications 1370 and/or other software components/modules. For example, the frameworks/middleware 1368 may provide various Graphic User Interface (GUI) functions, high-level resource management, high-level location services, and so forth. The frameworks/middleware 1368 may provide a broad spectrum of other APIs that may be used by the applications 1370 and/or other software components/modules, some of which may be specific to the OS 1350 or to a platform.

The application programs 1370 are also known more simply as applications and apps. One such app is a browser 1371, which is a software that can permit the user 192 to access other devices via the Internet, for example while using a Graphic User Interface (GUI). The browser 1371 includes program modules and instructions that enable the computer system 1395 to exchange network messages with a network, for example using Hypertext Transfer Protocol (HTTP) messaging.

The application programs 1370 may include one or more custom applications 1374, made according to embodiments. These can be made so as to cause their host computer to perform operations according to embodiments. Of course, when implemented by software, operations according to embodiments may be implemented much faster than may be implemented by a human mind; for example, tens or hundreds of such operations may be performed per second according to embodiments, which is much faster than a human mind can do.

Other such applications 1370 may include a contacts application, a book reader application, a location application, a media application, a messaging application, and so on. Applications 1370 may be developed using the ANDROID™ or IOS™ Software Development Kit (SDK) by an entity other than the vendor of the particular platform, and may be mobile software running on a mobile operating system. The applications 1370 may use built-in functions of the OS 1350, of the libraries 1360, and of the frameworks/middleware 1368 to create user interfaces for the user 192 to interact with.

The computer system 1395 moreover includes a bus bridge 1320 coupled to the system bus 1312. The computer system 1395 furthermore includes an input/output (I/O) bus 1321 coupled to the bus bridge 1320. The computer system 1395 also includes an I/O interface 1322 coupled to the I/O bus 1321.

For being accessed, the computer system 1395 also includes one or more Universal Serial Bus (USB) ports 1329. These can be coupled to the I/O interface 1322. The computer system 1395 further includes a media tray 1326, which may include storage devices such as CD-ROM drives, multi-media interfaces, and so on.

The computer system 1390 may include many components similar to those of the computer system 1395, as seen in FIG. 13. In addition, a number of the application programs may be more suitable for the computer system 1390 than for the computer system 1395.

The computer system 1390 further includes peripheral input/output (I/O) devices for being accessed by a user more routinely. As such, the computer system 1390 includes a screen 1391 and a video adapter 1328 to drive and/or support the screen 1391. The video adapter 1328 is coupled to the system bus 1312.

The computer system 1390 also includes a keyboard 1323, a mouse 1324, and a printer 1325. In this example, the keyboard 1323, the mouse 1324, and the printer 1325 are directly coupled to the I/O interface 1322. Sometimes this coupling is via the USB ports 1329.

In this context, “machine-readable medium” refers to a component, device or other tangible media able to store instructions and data temporarily or permanently and may include, but is not be limited to, a portable computer diskette, a thumb drive, a hard disk, random-access memory (RAM), read-only memory (ROM), buffer memory, flash memory, optical media, magnetic media, cache memory, an Erasable Programmable Read-Only Memory (EPROM), an optical fiber, a portable compact disc read-only memory (CD-ROM), an optical storage device, a magnetic storage device, or any suitable combination of the foregoing. The machine that would read such a medium includes one or more processors 1394.

The term “machine-readable medium” should be taken to include a single medium or multiple media (e.g., a centralized or distributed database, or associated caches and servers) able to store instructions that a machine such as a processor can store, erase, or read. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methods described herein. Accordingly, instructions transform a general, non-programmed machine into a particular machine programmed to carry out the described and illustrated functions in the manner described.

A computer readable signal traveling from, to, and via these components may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The above-mentioned embodiments have one or more uses. Aspects presented below may be implemented as was described above for similar aspects. (Some, but not all of these aspects have even similar reference numerals, for ease of explanation.)

Operational examples and sample use cases are possible where the attribute of an entity in a dataset is any one of the entity's name, type of entity, a physical location such as an address, a contact information element, an affiliation, a characterization of another entity, a characterization by another entity, an association or relationship with another entity (general or specific instances), an asset of the entity, a declaration by or on behalf of the entity, and so on. Different resources may be produced in such instances, and so on.

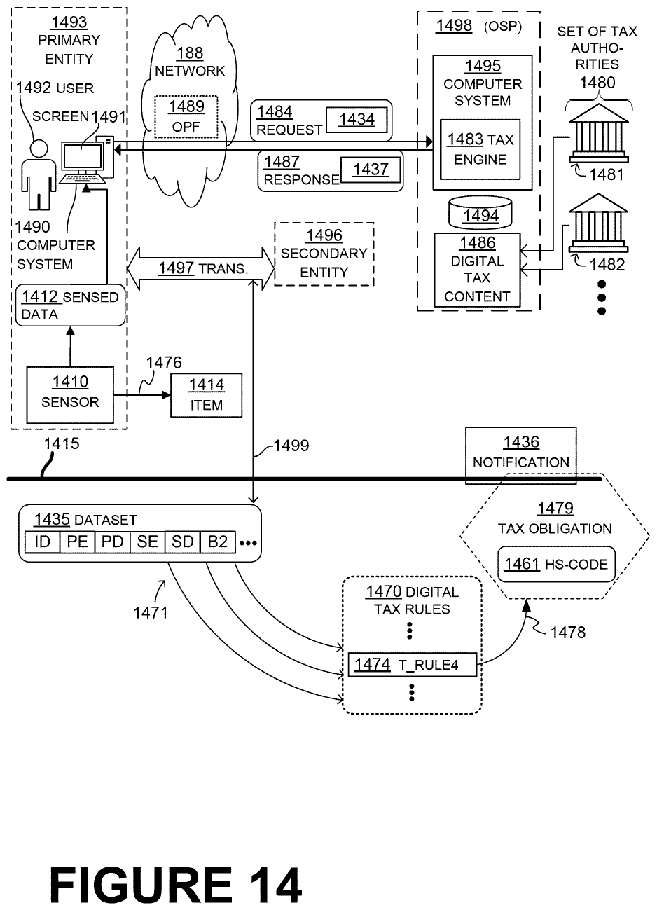

FIG. 14 is a diagram for an operational example where a buy-sell transaction 1497 is a use case of the relationship instance 197. The transaction 1497 is conducted between a primary entity 1493, which is a seller of an item, and a secondary entity 1496, which is the item's buyer. The item may be a product, such as an article or substance that is manufactured or refined for sale, or an aspect of one or more products. A tax obligation 1479 often arises from the transaction 1497 when the item travels across borders, such as borders of states, countries, etc. - in particular an import and/or export tariff or duty must be paid by either the primary entity 1493 or the secondary entity 1496. A computation of the tax obligation 1479 is a use case of producing the resource 179.

It will be recognized that aspects of FIG. 14 have similarities with aspects of FIG. 1. Portions of such aspects may be implemented as described for analogous aspects of FIG. 1. In particular, a thick horizontal line 1415 separates FIG. 14, although not completely or rigorously, into a top portion and a bottom portion. Above the line 1415 are shown elements with emphasis mostly on entities, components, their relationships, and their interactions, while below the line 1415 are shown elements with emphasis mostly on processing of data that takes place often within one or more of the components that are above the line 1415.

Above the line 1415, a computer system 1495 is shown, which is used to help customers, such as a user 1492, with tax compliance. For instance, the user 1492 may log into the computer system 1495 by using credentials, such as a user name, a password, a token, and so on. Further in this example, the computer system 1495 is part of an OSP 1498 that is implemented as a Software as a Service (SaaS) provider, for being accessed by the user 1492 online. As such, the OSP 1498 can be an online service provider for clients. Alternately, the functionality of the computer system 1495 may be provided locally to a user.

The user 1492 may be a single user or multiple users. The user 1492 may use a computer system 1490 that has a screen 1491. In embodiments, the user 1492 and the computer system 1490 are considered part of the primary entity 1493, which is also known as entity 1493. The primary entity 1493 can be a business, such as a seller of items, a reseller, a buyer, a service business, and so on. In such instances, the user 1492 can be an employee, a contractor, or otherwise an agent of the entity 1493. In use cases the entity 1493 is a seller, the secondary entity 1496 is a buyer, and together they are performing the buy-sell transaction 1497. The buy-sell transaction 1497 may involve an operation, such as an exchange of data to form an agreement. This operation can be performed in person, or over the network 188, etc. In such cases the entity 1493 can even be an online seller, but that is not necessary. The transaction 1497 will have data that is known to the entity 1493, similarly with what was described by the relationship instance 197 of FIG. 1.

The computer system 1490 may receive sensed data 1412 from a sensor 1410. The sensor 1410 may be a barcode reader, RFID reader, camera, QR code reader, infrared sensor, or any other type of sensor or group of sensors that are usable to sense an item. The sensor 1410 may be used to sense an item, such as the item 1414 as indicated by the connector 1476. The sensor 1410 transmits sensed data received by sensing the item, such as sensed data 1412, to the computer system 1490. Although a single sensor 1410 is shown in FIG. 14, embodiments are not so limited, and the primary entity 1493 may be associated with multiple sensors that are each able to obtain sensed data regarding items.

In a number of instances, the user 1492 and/or the entity 1493 use software applications to manage their business activities, such as sales, resource management, production, inventory management, delivery, billing, and so on. The user 1492 and/or the entity 1493 may further use accounting applications to manage purchase orders, sales invoices, refunds, payroll, accounts payable, accounts receivable, and so on. Such software applications, and more, may be used locally by the user 1492, or from an Online Processing Facility (OPF) 1489 that has been engaged for this purpose by the user 1492 and/or the entity 1493. In such use cases, the OPF 1489 can be a Mobile Payments system, a Point Of Sale (POS) system, an Accounting application, an Enterprise Resource Planning (ERP) provider, an e-commerce provider, an electronic marketplace, a Customer Relationship Management (CRM) system, and so on.

Businesses have tax obligations to various tax authorities of respective tax jurisdictions. These tax obligations are challenging. A first challenge is in making the related determinations. Tax-related determinations, made for the ultimate purpose of tax compliance, are challenging because the underlying statutes and tax rules and guidance issued by the tax authorities are very complex. There are various types of tax, such as: sales tax; use tax; excise tax; value-added tax; cross-border taxes including customs, tariffs, or duties; and many more. Some types of tax are industry specific. Each type of tax has its own set of rules. Additionally, statutes, tax rules, and rates change often, and new tax rules are continuously added. Compliance becomes further complicated when a taxing authority offers a temporary tax holiday, during which certain taxes are waived.

Tax jurisdictions are defined mainly by geography. Businesses have tax obligations to various tax authorities within the respective tax jurisdictions. There are various tax authorities, such as that of a group of countries, of a single country, of a state, of a county, of a municipality, of a city, of a local district such as a local transit district and so on. So, for example, when a business sells items in transactions that can be taxed by a tax authority, the business may have the tax obligations to the tax authority. These obligations include requiring the business to: a) register itself with the tax authority's taxing agency, b) set up internal processes for collecting a tax obligation in accordance with the tax rules of the tax authority, c) maintain records of the sales transactions and of the collected tax obligations in the event of a subsequent audit by the taxing agency, d) periodically prepare a form (“tax return”) that includes an accurate determination of the amount of the money owed to the tax authority as tax obligations because of the sales transactions, e) file the tax return with the tax authority by a deadline determined by the tax authority, and f) pay (“remit”) that amount of money to the tax authority. In such cases, the filing and payment frequency and deadlines are determined by the tax authority.

A challenge for businesses is that the above-mentioned software applications often cannot provide tax information that is accurate enough for the businesses to be tax compliant with all the relevant tax authorities. The lack of accuracy may manifest itself as errors in the amounts determined to be owed as taxes to the various tax authorities, and it is plain not good to have such errors. For example, businesses that sell products and services have risks whether they over-estimate or under-estimate the tax obligation due from a sale transaction. The tax obligation may include a customs tax, tariff, import tax, export tax, sales tax, etc., for items that travel from one jurisdiction to another, such as items shipped from a first country to a second country. On the one hand, if a seller over-estimates the tax obligation due, then the seller collects more tax obligation from the buyers than was due. Of course, the seller may not keep this surplus tax obligation, but instead must pay it to the tax authorities - if the seller cannot refund it to the buyers. If a buyer later learns that they paid unnecessarily more tax than was due, the seller risks at least harm to their reputation. Sometimes the buyer will have the option to ask the state for a refund of the excess tax by sending an explanation and the receipt, but that is often not done as it is too cumbersome for the amounts of money involved. On the other hand, if a seller under-estimates the tax obligation due, then the seller collects less tax from the buyers, and therefore pays less of their tax obligation to the authorities than was actually due. That is an underpayment of tax that will likely be discovered later, if the tax authority audits the seller. Then the seller will be required to pay the difference, plus fines and/or late fees, because ignorance of the law is not an excuse. Further, one should note that at least a portion of the tax obligation can be considered trust-fund taxes, meaning that the management of a company may be held personally liable for the unpaid tax.

For sales in particular, making correct determinations for of the tax obligation is even more difficult. There are a number of factors that contribute to its complexity.

First, some country, state, and local tax authorities have origin-based tax rules, while others have destination-based tax rules. Accordingly, a tax obligation may be charged from the seller's location, meaning according to the rules of the tax authority of the seller, or from the buyer's location, meaning according to the rules of the tax authority of the buyer.

Second, the various tax authorities assess different, i.e., non-uniform, percentage rates of the sales price as the tax obligation, for the purchase and sale of items that involve their various tax jurisdictions. These tax jurisdictions include various countries, states, counties, cities, municipalities, special taxing jurisdictions, and so on. As the United States switched, largely but not completely, from primarily origin-based sales tax to destination-based tax, the number of tax jurisdictions rapidly multiplied, and the incentives for local governments to implement new and varied tax rules and ever smaller jurisdictions multiplied. As such, there are over 10,000 different tax jurisdictions in the US, with many partially overlapping. Their sizes vary from as large as many square miles to as small as a single building. In parallel, tens of thousands of tax rules and tax rates have been developed. Furthermore, other countries have their own tax rules and tax jurisdictions. Thus, the tax rules and tax rates are exponentially greater for items traveling across the borders of countries.

Third, in some instances no sales tax is due at all because of the type of item sold. For example, in 2018 selling cowboy boots was exempt from sales tax in Texas, but not in New York. This non-uniformity gives rise to numerous individual taxability rules related to various products and services across different tax jurisdictions.

Fourth, in some instances a portion of the tax obligation is not due at all because of who the individual buyer is, and/or what the purchase is for. For example, certain entities are exempt from paying sales tax on their purchases, as long as they properly create and sign an exemption certificate and give it to the seller for each purchase made. Entities that are entitled to such exemptions may include wholesalers, resellers, non-profit charities, educational institutions, etc. Of course, who can be exempt is not exactly the same in each tax jurisdiction. And, even when an entity is entitled to be exempt, different tax jurisdictions may have different requirements for the certificate of exemption to be issued and/or remain valid. And, certificates of exemption may expire after some time, and may need to be renewed or reissued.

Fifth, it can be hard to determine which tax authorities a seller owes the tax obligation tax to. A seller may start with tax jurisdictions that it has a physical presence in, such as a main office, a distribution center or warehouse, an employee working remotely, and so on. Such ties with a tax jurisdiction establish the so-called physical nexus. However, a tax authority such as a state or even a city may set its own nexus rules for when a business is considered to be “engaged in business” with it, and therefore that business is subject to registration and collection of sales taxes. These nexus rules may include different types of nexus, such as affiliate nexus, click-through nexus, cookie nexus, economic nexus with thresholds, and so on. For instance, due to economic nexus, a remote seller may owe sales tax for sales made in the jurisdiction that are a) above a set threshold volume, and/or b) above a set threshold number of sales transactions.

Sixth, it can be hard to determine a grouping for an item which controls the extent of the tariff, customs tax, export tax, import tax, etc. (collectively “tariff”), that either a seller or buyer owes when the item travels between tax jurisdictions. The grouping is represented by a code, such as an HS code, and is determined based on attributes of an item. The HS code is used to determine a tariff for an item based on the destination and source of the item. The tariff is thus an aspect of the tax obligation. However, a seller may not have the expertise to determine which HS code accurately, and each country or other jurisdiction may change the tariff applied to items with certain HS codes at any time. Thus, sellers may not pay the correct tariff due to determining the wrong HS code, due to a change in the import and export laws for the jurisdiction, etc.

The economic nexus mentioned above can be even more complicated. Even where a seller might not have reached any of the thresholds for economic nexus, a number of states are promulgating marketplace facilitator laws that sometimes use such thresholds. According to such laws, intermediaries that are characterized as marketplace facilitators per laws of the state may have an obligation, instead of the seller, to collect sales tax on behalf of their sellers, and remit it to the state. The situation becomes even more complex when a seller sells directly to a state, and also via such an intermediary.

To help with such complex determinations, the computer system 1495 may be specialized for tax compliance. The computer system 1495 may have one or more processors and memory, for example as was described for the computer system 195 of FIG. 1. The computer system 1495 thus implements a tax engine 1483 to make the determinations of tax obligations. The tax engine 1483 may be similar to the service engine 183.

The computer system 1495 may further store locally entity data, i.e., data of user 1492 and/or of entity 1493, either of which/whom may be a customer, and/or a seller or a buyer in a sales transaction. The entity data may include profile data of the customer, and transaction data from which a determination of a tax obligation is desired. In the online implementation of FIG. 14, the OSP 1498 has a database 1494 for storing the entity data. This entity data may be inputted by the user 1492, and/or caused to be downloaded or uploaded by the user 1492 from the computer system 1490 or from the OPF 1489, or extracted from the computer system 1490 or from OPF 1489, and so on. In other implementations, a simpler memory configuration may suffice for storing the entity data.

A digital tax content 1486 is further implemented within the OSP 1498. The digital tax content 1486 can be a utility that stores digital tax rules 1470 for use by the tax engine 1483. As part of managing the digital tax content 1486, there may be continuous updates of the digital tax rules, by inputs gleaned from a set 1480 of different tax authorities 1481, 1482, etc. Updating may be performed by humans, or by computers, and so on. As mentioned above, the number of the different tax authorities in the set 1480 may be very large. In such use cases, tax jurisdictions such as a country, a state, a city, a municipality, etc. correspond to domains discussed earlier in this document.

For a specific determination of a tax obligation, the computer system 1495 may receive one or more datasets. A sample received dataset 1435 is shown just below line 1415. The dataset 1435 has values that can also be called dataset values, and be otherwise examples of what was described for the dataset values of the dataset 135 of FIG. 1. In this example, the computer system 1490 transmits a request 1484 that includes a payload 1434, and the dataset 1435 is received by the computer system 1495 parsing the received payload 1434. In this example the single payload 1434 encodes the entire dataset 1435, but that is not required, as mentioned above.

In this example, the dataset 1435 has been received because it is desired to determine any tax obligations arising from the buy-sell transaction 1497. As such, the sample received dataset 1435 has values that characterize attributes of the buy-sell transaction 1497, as indicated by a correspondence arrow 1499. Accordingly, in this example the sample received dataset 1435 has a value ID for an identity of the dataset 1435 and/or the transaction 1497. The dataset 1435 also has a value PE for the name of the primary entity 1493 or the user 1492, which can be the seller making sales transactions, some perhaps online. The dataset 1435 further has an optional value PD for relevant data of the primary entity 1493 or the user 1492, such as an address, place(s) of business, prior nexus determinations with various tax jurisdictions, and so on. The value PD is optional because it may be possible to look it up from the value PE. The dataset 1435 also has a value SE for the name of the secondary entity 1496, which can be the buyer. The dataset 1435 further has a value SD for relevant data of the secondary entity 1496, entity-driven exemption status, and so on. In some instances, the value SD can be optional, similarly with the value PD. The dataset 1435 has a numerical value B2 for the sale price of the item sold. The dataset 1435 may further have additional dataset values, as indicated by the ellipses in the right side of the dataset 1435. These values may characterize further attributes, such as what item was sold, for example by a Stock Keeping Unit (SKU), how many units of the item were sold in the transaction 1497, a date and possibly also time of the transaction 1497, and so on.

The digital tax rules 1470 are digital in that they are implemented for use by software, similarly with these rules 170. The digital tax rules 1470 can be created so as to accommodate legal tax rules that the set 1480 of different tax authorities 1481, 1482, etc. promulgate to apply within the boundaries of their tax jurisdictions. In the example of this diagram, only one sample digital tax rule is shown explicitly, namely rule T_RULE4 1474. In this diagram, all other such rules are indicated by the vertical ellipses.

Then the computer system 1495 may select a certain one of the digital tax rules 1470. In this example, the rule T_RULE4 1474 is thus selected. The selection of this particular rule is indicated also by the fact that an arrow 1478 begins from that rule. The arrow 1478 is similar to the arrow 178.

The computer system 1495 may thus select the certain rule T_RULE4 1474 responsive to one or more of the dataset values of the dataset 1435. The impact of the dataset 1435 in the selection is indicated by at least some of the arrows 1471, similarly with the arrows 171. For example, it can be recognized that a condition of the digital tax rule T_RULE4 1474 is met by one or more of the values of the dataset 1435. For instance, it can be further determined that, at the time of the sale, the buyer 1496 is located within the boundaries of a tax jurisdiction, that the seller 1493 has nexus with that tax jurisdiction, and that there is no tax holiday.

As such, the computer system 1495 may produce the tax obligation 1479, which is akin to producing the resource 179 of FIG. 1. The tax obligation 1479 can be produced by the computer system 1495 applying the certain digital tax rule T_RULE4 1474, as indicated by the arrow 1478. The impact of the dataset 1435 in producing the tax obligation 1479 is indicated by at least one of the arrows 1471. In this example, the identified certain digital tax rule T_RULE4 1474 may specify that a sales tax is due, the amount is to be determined by a multiplication of the sale price of the value B2 by a specific rate, the tax return form that needs to be prepared and filed, a date by which it needs to be filed, and so on.

The tax obligation 1479 is produced with an HS code, such as the HS code 1461. An HS code is an international code used by countries to determine a customs obligation for an item. See International Convention of The Harmonized Commodity Description and Coding System, Jun. 14, 1983; and Harmonized Tariff Schedule of the United States (2023) Basic Edition, January 2023; each of which are incorporated by reference herein. In cases where the present application conflicts with a document incorporated by reference, the present application controls. HS codes are numerical codes that classify an item and the country from which the item is leaving. An HS code may have up to 10 digits, which are each used to identify or classify an item, a country, and tariffs that apply to the item. Six digits may be used for the classification of items or commodities, however in some cases countries or other tax jurisdictions add additional digits for this classification. For example, the United States uses ten digits for classifying products for export, where the first six digits are the HS code number, and the next four digits represent other information related to the classification of the item. The HS code 1461 is determined by the OSP 1498 based on one or more attributes of an item, such as the item 1414. The HS code 1461 may be a six-digit HS code or a longer HS code that includes additional digits specified by one or more jurisdictions. For example, a pinball machine may have an HS code of 9504.30, while the code for the same pinball machine in the United States would be 9504.30.0010.

The computer system 1495 may then cause a notification 1436 to be transmitted. In the example of FIG. 14, the notification 1436 is caused to be transmitted by the computer system 1495 as an answer to the received dataset 1435. The notification 1436 can be about an aspect of the tax obligation 1479, similarly with the notification 136 of FIG. 1. For instance, the notification 1436 may inform that the tax obligation 1479 has been determined, where it can be found, what it is, or at least a portion or a statistic of its content, and so on.

The notification 1436 can be transmitted to one of an output device and another device that can be the remote device, from which the dataset 1435 was received. The output device may be the screen of a local user or a remote user. The notification 1436 may thus cause a desired image to appear on the screen, such as within a Graphical User Interface (GUI) and so on. The other device may be a remote device, as in this example. In particular, the computer system 1495 causes the notification 1436 to be communicated by being encoded as a payload 1437, which is carried by a response 1487. The response 1487 may be transmitted via the network 188 responsive to the received request 1484. The response 1487 may be transmitted to the computer system 1490, or to the OPF 1489, and so on. As such, the other device can be the computer system 1490, or a device of the OPF 1489, or the screen 1491 of the user 1492, and so on. In this example the single payload 1437 encodes the entire notification 1436, but that is not required, similarly with what is written above about encoding datasets in payloads. Of course, along with the aspect of the tax obligation 1479, it is advantageous to embed in the payload 1437 the ID value and/or one or more values of the dataset 1435. This will help the recipient correlate the response 1487 that they receive to their request 1484, and therefore match the received aspect of the tax obligation 1479 as the answer to the transmitted dataset 1435.

The digital tax rules 1470 can be implemented or organized in different ways. For example, these digital tax rules 1470 may have applicability conditions that relate to geographical boundaries, effective dates with possible temporary exceptions, item classification into categories, differently-treated parties, and so on, for determining where and when a certain digital tax rule is to be selected and applied, to determine the tax obligation 1479. These conditions may be expressed as logical conditions with ranges, dates, other data, and so on. Values of the dataset 1435 can be iteratively tested against these logical conditions according to arrows 1471. In such cases, the applicable tax rules may indicate how to compute one or more tax obligations, such as to indicate different types of taxes that are due, rules, rates, exemption requirements, reporting requirements, remittance requirements, the actual amounts of tax obligations, etc.

As with the digital resource rules 170, the digital tax rules 1470 may also be complex. While a certain one of them is eventually selected and applied to determine the tax obligation, more than one of them may be used for selecting that certain one.

FIG. 15 is a flowchart for illustrating a sample method 1500 for receiving data derived from item-sensed data related to a transaction to determine an HS code for the transaction, according to various embodiments described herein. In some embodiments, the actions performed in the method 1500 are similar to the actions performed in the method 600.

The process 1500 begins at 1505.

At 1510, the computer system 1490 receives a captured image of an item.

At 1515, the computer system 1490 transmits a request to an OSP, such as the OSP 1498, which includes the image of the item and an indication of a transaction between a primary entity and a secondary entity.

At 1520, the computer system 1490 receives a response from the OSP which includes one or more questions regarding the classification of the item.

At 1525, the computer system 1490 receives user input that includes one or more answers to the one or more questions.

At 1530 the computer system 1490 creates and transmits to the OSP a second response which includes the received user input.

At 1535, the computer system 1490 receives a third response from the OSP which includes an HS code that classifies the item based on at least one of the image, the user input, and the transaction.

At 1540, the computer system 1490 presents the HS code to a user.

At 1545, the process 1500 ends.

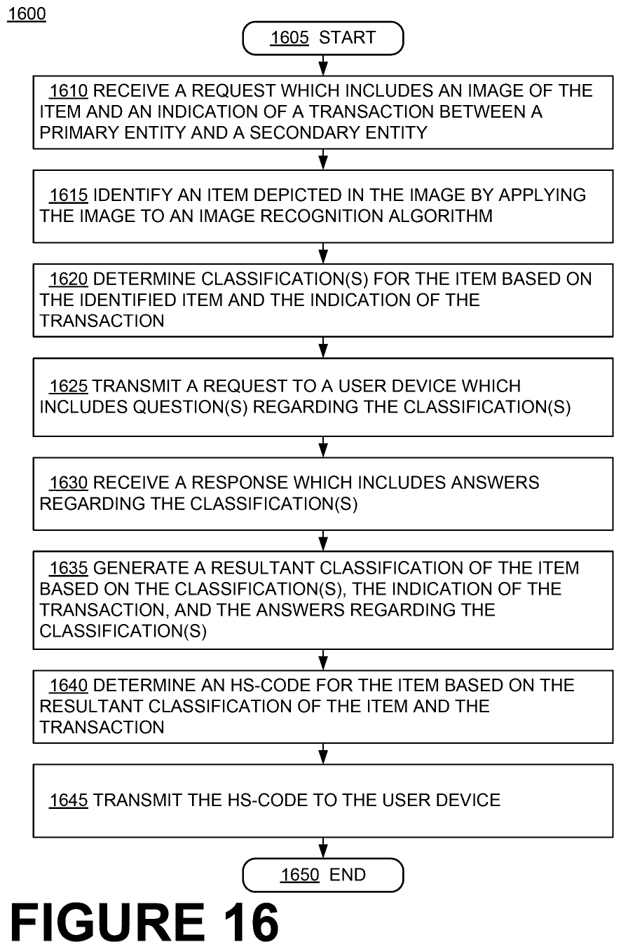

FIG. 16 is a flowchart for illustrating a sample method 1600 for generating an HS code for an item in a transaction, according to various embodiments described herein. In some embodiments, the actions performed in the method 1600 are similar to the actions performed in the method 700.

The method 1600 starts at 1605.

At 1610, the OSP 1498 receives a request which includes an image of the item and an indication of a transaction between a primary entity and a secondary entity.

At 1615, the OSP 1498 identifies an item depicted in the image by applying the image to an image recognition algorithm. In some embodiments, the image recognition algorithm includes a machine learning model trained to identify one or more items in an image.

At 1620, the OSP 1498 determines one or more classifications for the item based on the identified item and the indication of the transaction. In some embodiments, the OSP 1498 determines the one or more classifications by applying one or more machine learning models to data indicating the identified item and the indication of the transaction. For example, the OSP 1498 may use a machine learning model to identify one or more attributes of the identified item based on the identification of the item and the image. The OSP 1498 may use another machine learning model to determine the one or more classifications based on the identified attributes and the indicated transaction. In another example, the OSP 1498 may use a machine learning model to convert an image to text data. In such an example, the OSP 1498 may identify the item and one or more attributes of the item based on the text data, such as by applying a machine learning model trained to output attributes of an item to the text data.

At 1625, the OSP 1498 transmits a request to a user device which includes one or more questions regarding the one or more classifications.

At 1630, the OSP 1498 receives a response which includes answers regarding the one or more classifications.

At 1635, the OSP 1498 generates a resultant classification of the item based on the one or more classifications, the indication of the transaction, and the answers regarding the one or more classifications. The OSP 1498 may determine the resultant classification by applying the one or more classifications, the indication of the transaction, and the answers to one or more digital rules. In some embodiments, the OSP 1498 applies a machine learning model trained to output one or more classifications to the indication of the transaction and the answers regarding the one or more classifications. One or more digital rules may be used to train the machine learning model.

At 1640, the OSP 1498 determines an HS code for the item based on the resultant classification of the item and the transaction. In some embodiments, the OSP 1498 determines the HS code for the item by applying the resultant classification and the transaction to one or more digital rules.

AT 1645, the OSP 1498 transmits the HS code to the user device.

At 1650, the process 1600 ends.

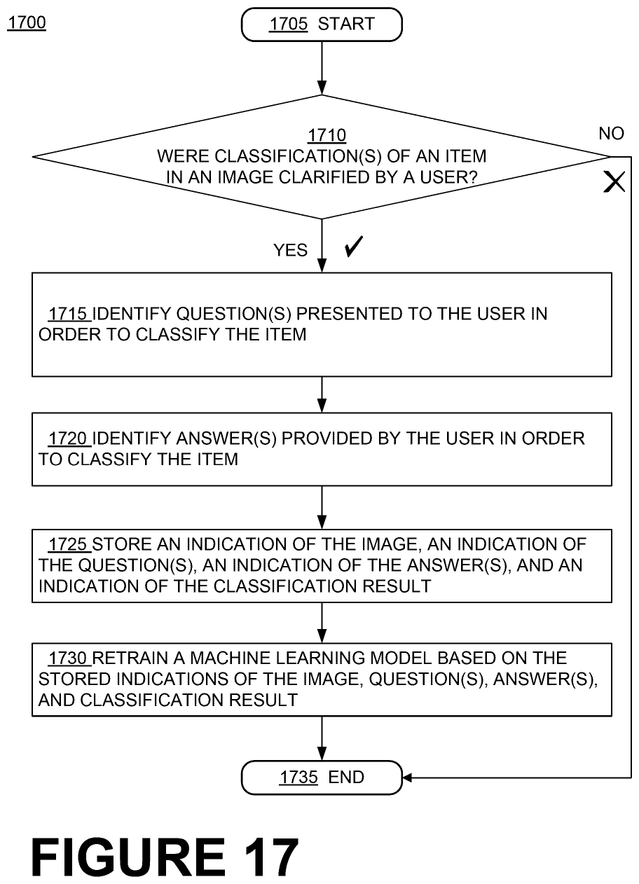

FIG. 17 is a flowchart for illustrating a sample method 1700 for to identify data for retraining a machine learning model to output one or more HS codes, according to various embodiments described herein. In some embodiments, the actions performed in the method 1700 are similar to the actions performed in the method 1100.

The method 1700 begins at 1705.

At 1710, the OSP 1498 determines whether one or more classifications of an item in an image were clarified by a user. If the one or more classifications were not clarified by a user, the method 1700 proceeds to 1735, otherwise, the method 1700 proceeds to 1715.

At 1715, the OSP 1498 identifies one or more questions that were presented to the user in order to classify the item. For example, in some embodiments, the OSP 1498 stores questions presented to users to classify items when the questions are generated.

At 1720, the OSP 1498 identifies one or more answers provided by the user in order to classify the item.

At 1725, the OSP 1498 stores an indication of the image, an indication of the one or more questions, an indication of the one or more answers, and an indication of the classification result.

At 1730, the OSP 1498, retrains a machine learning model based on the stored indications of the image, the one or more questions, the one or more answers, and the classification result. In some embodiments, the re-trained machine learning model is one or more of: a machine learning model for identifying an item in item-sensed data; a machine learning model for extracting one or more attributes regarding an item from item-sensed data; a machine learning model for identifying one or more resource classifications for an item based on one or more attributes of the item; and any other machine learning model described in this disclosure.

At 1735, the method 1700 ends.

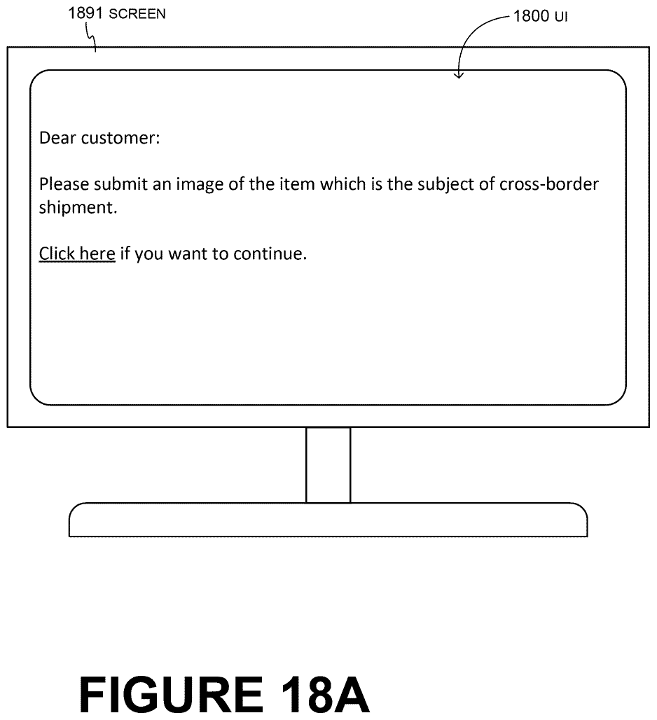

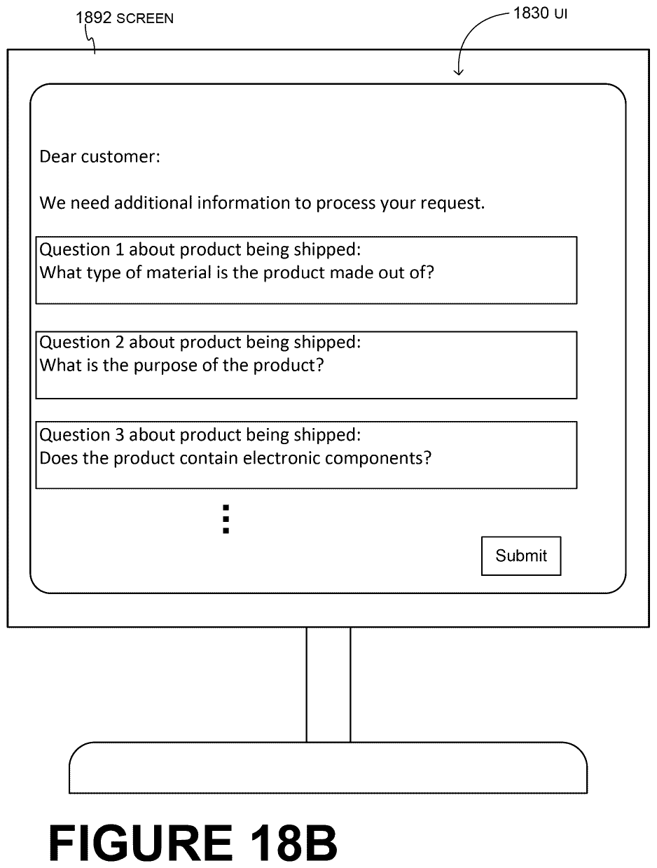

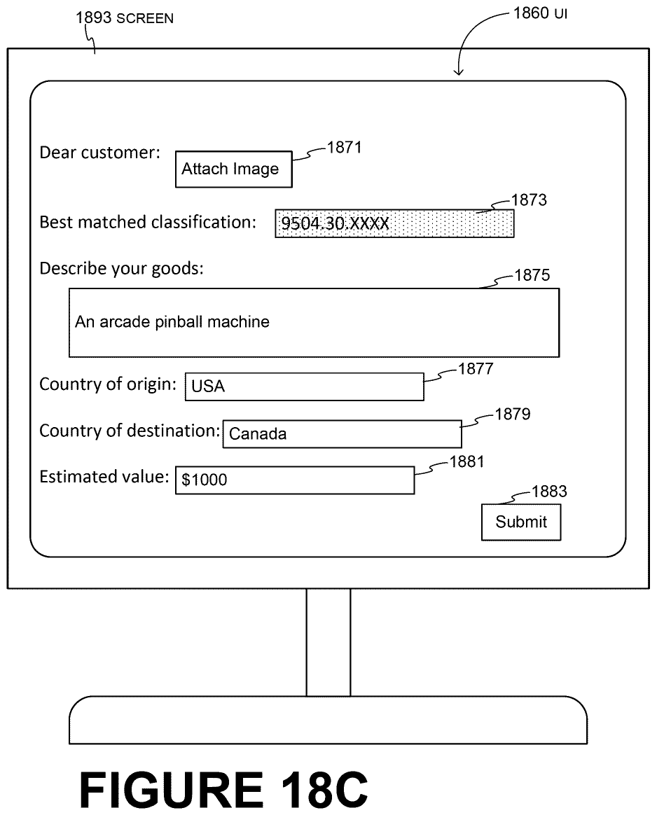

A primary entity may use the User Interfaces (UIs) described in FIGS. 18A-20 to transmit data related to an item and a transaction to an OSP, such as the OSP 198 or OSP 1498. The OSP communicates with a user associated with the primary entity via the UIs to obtain information regarding the item and transaction to determine an HS code for the item. The OSP may cause the UIs to present prompts to the user associated with the primary entity and to receive answers to the prompts. The OSP may also cause the UIs to present an HS code and other information related to the item or transaction to the user.

FIG. 18A is a sample view of a User Interface (UI) 1800, shown on a screen 1891, according to various embodiments described herein. The UI 1800 displays a prompt to a user associated with the primary entity requesting the submission of an image of an item which is the subject of a cross-border shipment. The user associated with the primary entity may submit an image via the UI 1800. In some embodiments, the user accesses a sensor, such as the sensor 110, to obtain the image of the item. In some such embodiments, the UI 1800 is able to cause the sensor to be activated. In some embodiments, the user submits sensed-data other than an image, such as: sound data; infrared data; data indicating a code for the item, such as a bar code, QR code, etc. ; or other data associated with an item that can be sensed by a sensor. After the image is submitted by the user, the UI 1800 is altered, changed, replaced, etc., to display another UI.

FIG. 18B is a sample view of a UI 1830, shown on a screen 1892, according to various embodiments described herein. The UI 1830 displays questions to a user that an OSP, such as the OSP 198 or OSP 1498, has generated in order to obtain additional information needed to determine a resource code for an item. The UI 1830 receives input from the user in response to the questions displayed by the UI 1830. The input from the user is transmitted to the OSP. In some embodiments, the questions displayed by the UI 1830 are questions whose answers assist the OSP in identifying the item and extracting one or more attributes regarding the item. In some embodiments, the questions displayed by the UI 1830 are questions whose answers assist the OSP in identifying a classification or resource code for the item.

FIG. 18C is a sample view of a UI 1860, shown on a screen 1893, according to various embodiments described herein. The UI 1860 is a sample interface through which a user inputs information regarding an item and transaction to receive a resource code or classification code for the item. The UI 1860 includes an image attachment button 1871, a classification text box 1873, a description text box 1875, an origin country text box 1877, a destination country text box 1879, a value text box 1881, and a submit button 1883.

Interacting with the image attachment button 1871 causes a computer system, such as the computer system 190 or 1490, presenting the UI 1860 to allow a user to select an image of an item to transmit to an OSP, such as the OSP 198 or OSP 1498. Interacting with the description text box 1875 allows a user to input text data indicating a description of the item. Interacting with the origin country text box 1877 allows a user to input text data indicating the country that the item will originate in. Interacting with the destination country text box 1879 allows a user to input text data indicating the country that is the destination of the item. Interacting with the value text box 1881 allows a user to input data indicating the value of the item.

Interacting with the submit button 1883 causes the computer system presenting the UI 1860 to transmit the data included in the description text box 1875, the origin country text box 1877, the destination country text box 1879, the value text box 1881, and the selected image to the OSP. The OSP may return a classification code that is displayed in the classification text box 1873. The classification text box 1873 includes text data indicating a classification code, HS code, or other indication of the item's classification that is determined by the OSP.

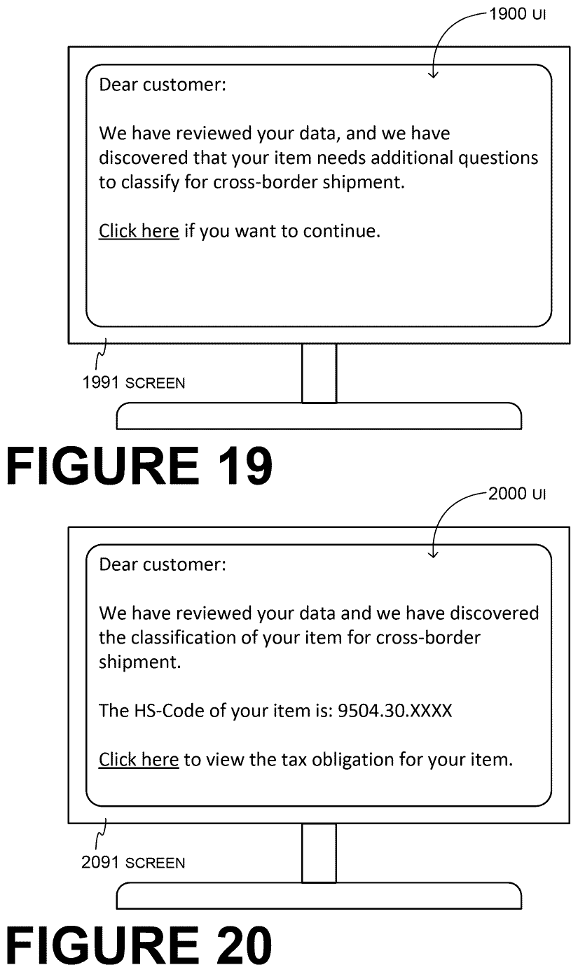

FIG. 19 is a sample view of a UI 1900, shown on a screen 1991, according to various embodiments described herein. The UI 1900 is a sample interface that indicates to a user that additional information is needed in order to determine an HS-code for an item. An OSP, such as the OSP 198 or OSP 1498, may cause a computer system associated with a primary entity, such as a computer system 190 or 1490, to display the UI 1900 after the OSP determines that additional information is required to determine an HS code for an item. In some embodiments, the OSP transmits one or more prompts to the computer system presenting the UI 1900, and interacting with the UI 1900 causes the prompts to be presented to a user, such as by using an interface similar to the UI 1830 described above in connection with FIG. 18B.

FIG. 20 is a sample view of a UI 2000, shown on a screen 2091, according to various embodiments described herein. The UI 2000 is a sample interface that indicates to a user an HS-code that was determined for an item that is subject to a transaction between a primary entity and a secondary entity. An OSP, such as the OSP 198 or OSP 1498, may cause a computer system associated with a primary entity, such as a computer system 190 or 1490, to display the UI 2000 after the OSP has determined the HS code for an item based on information submitted by a user.

In the methods described above, each operation can be performed as an affirmative act or operation of doing, or causing to happen, what is written that can take place. Such doing or causing to happen can be by the whole system or device, or just one or more components of it. It will be recognized that the methods and the operations may be implemented in a number of ways, including using systems, devices and implementations described above. In addition, the order of operations is not constrained to what is shown, and different orders may be possible according to different embodiments. Examples of such alternate orderings may include overlapping, interleaved, interrupted, reordered, incremental, preparatory, supplemental, simultaneous, reverse, or other variant orderings, unless context dictates otherwise. Moreover, in certain embodiments, new operations may be added, or individual operations may be modified or deleted. The added operations can be, for example, from what is mentioned while primarily describing a different system, apparatus, device or method.

A person skilled in the art will be able to practice the present invention in view of this description, which is to be taken as a whole. Details have been included to provide a thorough understanding. In other instances, well-known aspects have not been described, in order to not obscure unnecessarily this description.

Some technologies or techniques described in this document may be known. Even then, however, it does not necessarily follow that it is known to apply such technologies or techniques as described in this document, or for the purposes described in this document.

This description includes one or more examples, but this fact does not limit how the invention may be practiced. Indeed, examples, instances, versions or embodiments of the invention may be practiced according to what is described, or yet differently, and also in conjunction with other present or future technologies. Other such embodiments include combinations and sub-combinations of features described herein, including for example, embodiments that are equivalent to the following: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

A number of embodiments are possible, each including various combinations of elements. When one or more of the appended drawings - which are part of this specification - are taken together, they may present some embodiments with their elements in a manner so compact that these embodiments can be surveyed quickly. This is true even if these elements are described individually extensively in this text, and these elements are only optional in other embodiments.

In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the claimed invention.

In this document, the phrases “constructed to”, “adapted to” and/or “configured to” denote one or more actual states of construction, adaptation and/or configuration that is fundamentally tied to physical characteristics of the element or feature preceding these phrases and, as such, reach well beyond merely describing an intended use. Any such elements or features can be implemented in a number of ways, as will be apparent to a person skilled in the art after reviewing the present disclosure, beyond any examples shown in this document.

Parent patent applications: Any and all parent, grandparent, great-grandparent, etc. patent applications, whether mentioned in this document or in an Application Data Sheet (“ADS”) of this patent application, are hereby incorporated by reference herein as originally disclosed, including any priority claims made in those applications and any material incorporated by reference, to the extent such subject matter is not inconsistent herewith.

Reference numerals: In this description a single reference numeral may be used consistently to denote a single item, aspect, component, or process. Moreover, a further effort may have been made in the preparation of this description to use similar though not identical reference numerals to denote other versions or embodiments of an item, aspect, component or process that are identical or at least similar or related. Where made, such a further effort was not required, but was nevertheless made gratuitously so as to accelerate comprehension by the reader. Even where made in this document, such a further effort might not have been made completely consistently for all of the versions or embodiments that are made possible by this description. Accordingly, the description controls in defining an item, aspect, component or process, rather than its reference numeral. Any similarity in reference numerals may be used to infer a similarity in the text, but not to confuse aspects where the text or other context indicates otherwise.

The claims of this document define certain combinations and sub-combinations of elements, features and acts or operations, which are regarded as novel and non-obvious. The claims also include elements, features and acts or operations that are equivalent to what is explicitly mentioned. Additional claims for other such combinations and sub-combinations may be presented in this or a related document. These claims are intended to encompass within their scope all changes and modifications that are within the true spirit and scope of the subject matter described herein. The terms used herein, including in the claims, are generally intended as “open” terms. For example, the term “including” should be interpreted as “including but not limited to,” the term “having” should be interpreted as “having at least,” etc. If a specific number is ascribed to a claim recitation, this number is a minimum but not a maximum unless stated otherwise. For example, where a claim recites “a” component or “an” item, it means that the claim can have one or more of this component or this item.

In construing the claims of this document, 35 U.S.C. § 112(f) is invoked by the inventor(s) only when the words “means for” or “steps for” are expressly used in the claims. Accordingly, if these words are not used in a claim, then that claim is not intended to be construed by the inventor(s) in accordance with 35 U.S.C. § 112(f).

What is claimed is:

1. A system, comprising:
one or more processors;
one or more non-transitory computer-readable storage media coupled to the one or more processors, the media having stored thereon instructions which, when executed by the one or more processors, result in operations including at least:
receiving a dataset indicative of a relationship instance between a primary entity and a secondary entity;
identifying, by the one or more processors, a first domain based on the primary entity;
identifying, by the one or more processors, a second domain based on the secondary entity;
determining, based on contents of the dataset, one or more attributes related to the item;
in response to the determining, applying a machine learning model to the one or more attributes, an indication of the first domain, and an indication of the second domain, the machine learning model being configured to output one or more resource codes based on one or more attributes, an indication of a first domain, and an indication of a second domain as inputs;
looking up one or more digital rules regarding the relationship instance based on the indication of the first domain, the indication of the second domain, and the relationship instance;
determining a resultant resource code based on the one or more resource codes output by the machine learning model, the one or more digital rules, the one or more attributes, the indication of the first domain, and the indication of the second domain; and
generating a response based on the determined resultant resource code.

2. The system of claim 1, in which the instructions, when executed by the one or more processors to determine one or more attributes related to the item, result in further operations including at least:
accessing item-sensed data in the dataset, by the one or more processors;
generating, from the item-sensed data, by the one or more processors, item identity data indicative of the identity of the item, the item being related to the proposed relationship instance; and
determining, by the one or more processors, the one or more attributes related to the item based on the item identity data and the item-sensed data.

3. The system of claim 2, in which the instructions, when executed by the one or more processors to generate item identity data, result in further operations including at least:
generating, from the item-sensed data, by the one or more processors, text data describing one or more aspects of the item;
generating, from the text data, by the one or more processors, the item identity data; and
determining, by the one or more processors, the one or more attributes based on the item identity data, the item-sensed data, and the text data.

4. The system of claim 3, in which the instructions, when executed by the one or more processors to generate text data describing one or more aspects of the item, result in further operations including at least:
transmitting, by the one or more processors, one or more prompts to a user device associated with the primary entity;
receiving, from the user device, a response to the one or more prompts; and
generating, by the one or more processors, from the item-sensed data and the response, text data describing one or more aspects of the item.

5. The system of claim 3, in which the dataset further comprises additional text data describing one or more aspects of the item, and in which the instructions, when executed by the one or more processors to determine the one or more attributes, result in further operations including at least:
determining, by the one or more processors, the one or more attributes based on the item identity data, the text data, the item-sensed data, and the additional text data.

6. The system of claim 3, in which the item-sensed data is image data and in which the instructions, when executed by the one or more processors to generate item text data, result in further operations including at least:
applying a machine learning model to the image data, the machine learning model being configured to output text data based on image data.

7. The system of claim 6, in which the instructions, when executed by the one or more processors to determine one or more attributes, result in further operations including at least:
applying a machine learning model to the item identity data and the text data, the machine learning model being configured to output one or more attributes based on text data and item identity data.

8. The system of claim 2, in which the item-sensed data is image data.

9. The system of claim 1, in which the instructions, when executed by the one or more processors, result in further operations including at least:
causing the response to be transmitted to a user device associated with the primary entity.

10. The system of claim 1, in which the instructions, when executed by the one or more processors, result in further operations including at least:
causing the response to be transmitted to a user device associated with an entity that is not the primary entity.

11. The system of claim 1, in which the instructions, when executed by the one or more processors to determine the resultant resource code, result in further operations including at least:
determining whether the one or more resource codes output by the machine learning model should be refined;
based on a determination that the one or more resource codes should be refined, generating, by the one or more processors, one or more prompts based on the one or more resource codes output by the machine learning model and the one or more attributes related to the item;
transmitting, by the one or more processors, the one or more prompts to a user device associated with the primary entity;
receiving, from the user device, a response to the one or more prompts; and
determining, by the one or more processors, the resultant resource code based on the one or more resource codes, the one or more digital rules, the one or more attributes, the indication of the first domain, the indication of the second domain, and the response to the one or more prompts.

12. The system of claim 11, in which the instructions, when executed by the one or more processors to determine whether the one or more resource codes output by the machine learning model should be refined, result in further operations including at least:
determining, by the one or more processors, an accuracy measure of the one or more resource codes output by the machine learning model based on the output of the machine learning model; and
determining, by the one or more processors, that the one or more resource codes should be refined based on the determined accuracy measure of the one or more resource codes.

13. The system of claim 11, in which the instructions, when executed by the one or more processors to generate the one or more prompts, result in further operations including at least:
generating, by the one or more processors, the one or more prompts based on the digital rules, the one or more resources codes, and the one or more attributes related to the item.

14. The system of claim 11, in which the instructions, when executed by the one or more processors, result in further operations including at least:
determining, by the one or more processors, an accuracy measure of the one or more resource codes output by the machine learning model based on the output of the machine learning model; and
determining, by the one or more processors, that the one or more resource codes should be refined based on the determined accuracy measure of the one or more resource codes.

15. The system of claim 11, in which the instructions, when executed by the one or more processors, result in further operations including at least:
determining, by the one or more processors, whether the response to the one or more prompts was used to determine the resultant resource code; and
retraining, by the one or more processors, the machine learning model based on the one or more attributes, the one or more resource codes, and the resultant resource code.

16. The system of claim 1, in which the instructions, when executed by the one or more processors to apply the machine learning model, result in further operations including at least:
determining, by the one or more processors, a first classification of the item based on the one or more attributes;
generating, by the one or more processors, one or more prompts based on the determined classification;
transmitting, by the one or more processors, the one or more prompts to a user device associated with the primary entity;
receiving, from the user device, a response to the one or more prompts;
determining, by the one or more processors, a second classification of the item based on the response to the one or more prompts and the one or more attributes; and
applying the machine learning model to the second classification of the item, the one or more attributes, the indication of the first domain, and the indication of the second domain.

17. The system of claim 1, in which the instructions, when executed by the one or more processors, result in further operations including at least:
accessing item-sensed data in the dataset, by the one or more processors, the item-sensed data being indicative of the item;
determining whether the identity of the item indicated by the item-sensed data is recognized, by the one or more processors, based on a repository of item-sensed data for classified items;
based on a determination that the identity of the item indicated by the item-sensed data is not recognized:
receiving user input indicating the identity of the item; and
designating the item-sensed data and the identity of the item as training data.

18. The system of claim 17, in which the instructions, when executed by the one or more processors to determine the resultant resource code, result in further operations including at least:
determining, by the one or more processors, whether the item-sensed data can be used to obtain the resultant resource code;
based on a determination that the item-sensed data cannot be used to obtain the resultant resource code, receiving user input indicating the resultant resource code; and
designating the resultant resource code, the item-sensed data, and the identity of the item as training data.
